(19) United States
(12) Patent Application Publication
(10) Pub. No.: US 2025/0274075 A1
(43) Pub. Date: Aug. 28, 2025

(54) Solar Tracker Bearing Apparatus

(71) Applicant: OMCO SOLAR, LLC, Phoenix, AZ (US)

(72) Inventors: Andrew James Ballentine, Tempe, AZ (US); David J. Wilson, Glendale, AZ (US)

(21) Appl. No.: 19/207,228

(22) Filed: May 13, 2025

Related U.S. Application Data
(63) Continuation-in-part of application No. 17/195,568, filed on Mar. 8, 2021, now Pat. No. 12,301,163.

(51) Int. Cl. H02S 20/32; F16M 11/10

(52) U.S. Cl. CPC H02S 20/32; F16M 11/10

(57) ABSTRACT

A solar tracker bearing apparatus mountable to an upright support post for rotatably supporting a torque tube beam of a solar tracker assembly and including: a rotatable bearing assembly supported for rotation about an axis of rotation by a stationary saddle assembly. The rotatable bearing assembly includes a central portion and first and second spaced apart arcuate peripheral portions, the central portion defining a beam slot, the first arcuate peripheral portion including a first arcuate rim bearing and the second arcuate peripheral portion including a second arcuate rim bearing, and the first and second rim bearings being spaced apart in a direction parallel to the axis of rotation of the rotatable bearing assembly. The stationary saddle assembly includes a first arcuate bearing race slidably supporting the first arcuate rim bearing and a spaced apart second arcuate bearing race slidably supporting the second arcuate rim bearing.

### CROSS-REFERENCE TO RELATED APPLICATIONS

The present application is a continuation-in-part application of co-pending U.S. application Ser. No. 17/195,568, filed Mar. 8, 2021, entitled Solar Tracker Bearing Apparatus, published as Pub. No. US 2021/019418 A1, published on Jun. 24, 2021, which will issue as U.S. Pat. No. 12,301,163 on May 13, 2025, which is a continuation-in-part of U.S. application Ser. No. 16/058,418, filed Aug. 8, 2018, entitled Solar Tracker Bearing Apparatus, published as Pub. No. US 2020/0052643 A1, published on Feb. 13, 2020, which issued as U.S. Pat. No. 10,944,354 on Mar. 9, 2021. The present application claims priority from above-identified application Ser. No. 17/195,568 and Ser. No. 16/058,418, Pub. Nos. US 2021/0194418 A1 and US 2020/0052643 A1, and U.S. Pat. No. 10,944,354 and, when issued, U.S. Pat. No. 12,301,163, all of which are incorporated by reference herein in their respective entireties, for any and all purposes.

### TECHNICAL FIELD

The present disclosure relates to a solar tracker bearing assembly or apparatus for a solar tracker system including a plurality of photovoltaic modules supported on a frame assembly and, more specifically, to a solar tracker bearing assembly including a rotatable bearing assembly supported for rotation about an axis of rotation by a stationary saddle assembly, the rotatable bearing assembly includes first and second bearing members defining an interior beam slot for receiving a central support beam or torque tube beam of the solar tracker system and first and second spaced apart peripheral rim bearings, and the stationary saddle assembly including first and second saddle members defining first and second spaced apart arcuate bearing races respectively receiving the first and second peripheral rim bearings.

### BACKGROUND

Various types of solar tracker systems are known including a horizontal, single axis solar tracker system. A horizontal, single axis solar tracker system includes a frame for supporting a plurality of photovoltaic modules. The frame includes a support beam such as a torque tube beam and an array module rails which support the plurality of photovoltaic modules. The support beam or torque tube beam is typically comprised of one or more torque tube beam segments affixed in a linear fashion by collars between adjacent segment ends. The torque tube beam may be comprised of a plurality of segments of predetermined length, i.e., 40 foot segments. The module rails are typically spaced uniformly along the torque tube beam and attached to the torque tube beam via a plurality of brackets. The photovoltaic modules, in turn, are secured to the module rails via a plurality of clamps between adjacent pairs of the rails. An extent of the frame extends in two dimensions, length, generally perpendicular to the path or arc of the sun in the sky, and width, generally parallel to the path of sun in the sky. An actuator mechanism, such as a slew drive, is coupled to the torque tube beam to pivot or swing the torque tube beam about an axis of rotation to change an angle of inclination of the frame and thereby adjust the light receiving surfaces of the plurality of photovoltaic modules to track the movement of the sun across the sky so that the photovoltaic modules are maximally exposed to the sun to throughout the day. That is, the goal of the solar tracker system is to move or pivot the frame about an axis of rotation such that the light absorbing surfaces of the photovoltaic modules is generally orthogonal to the position of the sun, within, of course, the limits of the angle of inclination range of the solar tracking system frame.

In one typical embodiment of a single axis, horizontal solar tracker system, the torque tube beam extends horizontally along the length of the frame and, to achieve a proper balance, module rails are orthogonal to and centered about the torque tube beam so that a total weight of the frame and the plurality of photovoltaic modules, and associated clamps and brackets/fasteners, is approximately equally distributed on either side of the torque tube beam. A slew drive is approximately centered along the length of the torque tube beam and includes first and second couplers. A first portion of the torque tube beam is affixed to and extends from the first coupler on one side of the slew drive and a second portion of the torque tube beam is affixed to and extends from the second coupler on the opposite side of the slew drive. For example, the first portion of the torque tube beam may extend north from the slew drive and may be comprised of five 40 foot torque tube beam segments, while, the second portion of the torque tube beam may extend south from the slew drive and may similarly be comprised of five 40 foot torque tube beam segments, thus providing a total north-south extent or length of the torque tube beam of 400 feet. The slew drive pivots a table of the solar tracker system. The table of the solar tracking system is everything that pivots or swings about the axis of rotation and includes: a) the frame including the torque tube and the module rails; b) the photovoltaic modules; and c) the movable portions of a plurality of solar tracking bearing apparatuses that support the torque tube along its length. The axis of rotation of the solar tracker system extends parallel to the torque tube beam.

The torque tube beam is supported for pivoting movement about the axis of rotation by the plurality of solar tracker bearing apparatuses. Each of the solar tracker bearing apparatuses are affixed to a respective one of a plurality of spaced apart upright support posts which are anchored to or anchored in a substrate, such as the ground. The upright support posts are stationary and support the plurality of solar tracker bearing apparatuses, which, in turn, pivotally support the frame and the plurality of photovoltaic modules. Typically, one solar tracker bearing apparatus is mounted or coupled to each upright support post. Each solar tracker bearing apparatus includes a stationary portion, affixed to a support post, and a rotating portion, which rotates about the axis of rotation. Additionally, the slew drive is also mounted to its own support post.

The plurality of solar tracker bearing apparatuses pivotally support the torque tube beam for movement or pivoting about the axis of rotation. The actuator/controller mechanism, i.e., the slew drive, coupled to the torque tube beam provides to motive force to pivot the table about the axis of rotation and thus change the angle of inclination of the table. The plurality of solar tracker bearing apparatuses rotatably disposed between the torque tube beam and the upright support posts permit the torque tube beam to pivot with respect to the upright support posts and thereby allows the angle of inclination of the frame to be changed by the slew drive such that the plurality of photovoltaic module are maximally exposed to the sun within the range of the angle of inclination of the solar tracking system. The axis of rotation of the table of the solar tracker system is defined by a combination of aligned individual axes of rotation of the individual solar tracker bearing apparatuses. The slew drive is positioned such that it pivots the torque tube beam about the axis of rotation.

Solar tracker systems are often erected or installed at remote locations where sun exposure is maximized. As such, the solar tracker bearing apparatuses are utilized in outdoor locations, exposed to varying and potentially harsh weather conditions such as high wind conditions. More over such each solar tracker bearing apparatus receives a portion of a torque tube beam and thus supports a portion of the weight of the solar tracker frame and photovoltaic modules, when the frame and modules are subject to wind loads, snow loads and the like, such forces are transmitted via the torque tube beam through the solar tracker bearing apparatuses to the support posts. Thus, the solar tracker bearing apparatuses are subject to forces, including vector or linear forces of various directions and magnitudes, as well as various torque forces. Accordingly, it is desirable that a solar tracker bearing apparatuses be: a) durable and low maintenance over the useful life of the apparatuses; b) able to withstand linear and torque forces applied to the bearing apparatus; c) provide for stable support of the torque tube beam and the weight of the frame and photovoltaic modules over an extended useful life; d) easy to assemble on site at remote locations by workers with varying skill levels; and e) include mounting adjustment capability along multiple axes to compensate for the fact that the mounting surfaces provided by an individual upright support post may not be in perfect alignment with the torque tube beam to be received and rotatably supported by the solar tracker bearing apparatus. Providing such a solar tracker bearing apparatus is a continuing challenge for designers.

### SUMMARY

In one aspect, the present disclosure relates to a solar tracker bearing apparatus mountable to a support post for pivotally supporting a support beam of a solar tracker assembly, the solar tracker bearing apparatus comprising: a rotatable bearing assembly supported for rotation about an axis of rotation by a saddle assembly, the rotatable bearing assembly including a first bearing member and a second bearing member, the first bearing member including a central portion and a first arcuate peripheral portion and the second bearing member including a central portion and a second arcuate peripheral portion, the central portion of the first bearing member and the central portion of the second bearing member defining a beam slot, the first arcuate peripheral portion of the first bearing member including a first arcuate rim bearing and the second arcuate peripheral portion of the second bearing member including a second arcuate rim bearing, the first and second rim bearings being spaced apart in a direction parallel to the axis of rotation of the rotatable bearing assembly; a set of beam slot reinforcement members including a first beam slot reinforcement member affixed to the central portion of the first bearing member adjacent the beam slot; and the saddle assembly including a first arcuate bearing race and a spaced apart second arcuate bearing race, the first arcuate bearing race slidably supporting the first arcuate rim bearing of the rotatable bearing assembly and the second arcuate bearing race slidably supporting the second arcuate rim bearing of the rotatable bearing assembly.

In another aspect, the present disclosure relates to a solar tracker bearing apparatus mountable to a support post for pivotally supporting a support beam of a solar tracker assembly, the solar tracker bearing apparatus comprising: a rotatable bearing assembly supported for rotation about an axis of rotation by a saddle assembly, the rotatable bearing assembly including a first bearing member and a second bearing member, the first bearing member including a central portion and a first arcuate peripheral portion and the second bearing member including a central portion and a second arcuate peripheral portion, the central portion of the first bearing member and the central portion of the second bearing member defining a beam slot; the saddle assembly including a first saddle member and a second saddle member, the first saddle member including an upper bearing region extending from a lower support region, the upper bearing region including a first arcuate bearing race slidably supporting the first arcuate rim bearing of the rotatable bearing assembly, the second saddle member including an upper bearing region extending from a lower support region, the upper bearing region including a second arcuate bearing race slidably supporting the second arcuate rim bearing of the rotatable bearing assembly, the lower support region of the first saddle member including a horizontal flange and a vertical plate and the lower support region of the second saddle member including a horizontal flange and a vertical plate; and a set of saddle reinforcement members including a first saddle reinforcement member affixed between the horizontal flange and the vertical plate of the lower support region of the first saddle member and the second saddle reinforcement member affixed between the horizontal flange and the vertical plate of the lower support region of the first saddle member.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a schematic perspective view of a solar tracker assembly including a plurality of solar tracker bearing apparatuses of the present disclosure;

FIG. 2 is a schematic front elevation view of a first exemplary embodiment a solar tracker bearing apparatus of the present disclosure mounted to an upper mounting portion of a support post;

FIG. 3 is a schematic side elevation view of the solar tracker bearing apparatus of FIG. 2 and additionally includes a portion of a support beam or torque tube beam of a frame assembly of the solar tracker assembly;

FIG. 4 is a schematic perspective view of the solar tracker bearing apparatus of FIG. 2;

FIG. 5 is a schematic exploded perspective view of the solar tracker bearing apparatus of FIG. 2;

FIG. 6 is a schematic top plan view of the solar tracker bearing apparatus of FIG. 2 with a hold down bracket of a rotatable bearing assembly of the solar tracker bearing apparatus removed for clarity;

FIG. 7 is a schematic bottom plan view of the solar tracker bearing apparatus of FIG. 2;

FIG. 8 is a schematic longitudinal section view of the solar tracker bearing apparatus of FIG. 2 as seen from a plane indicated by the line 8-8 in FIG. 3;

FIG. 9 is a schematic longitudinal section view of the solar tracker bearing apparatus of FIG. 2 as taken along an axis of rotation of the rotatable bearing assembly of the solar tracker bearing apparatus;

FIG. 10 is a schematic back plan view of a first saddle member of a saddle assembly of the solar tracker bearing apparatus of FIG. 2;

FIG. 11 is a schematic top plan view of a W brace of a connecting assembly of the solar tracker bearing apparatus of FIG. 2;

FIG. 12 is a schematic top plan view of a post cap of the connecting assembly of the solar tracker bearing apparatus of FIG. 2;

FIG. 13 is a schematic top plan view of a stiffener member of the connecting assembly of the solar tracker bearing apparatus of FIG. 2;

FIG. 14 is a schematic front perspective view of the solar tracker bearing apparatus of FIG. 2 with a shim positioned in a beam slot of the rotatable bearing assembly; and

FIG. 15 is a schematic front elevation view of the solar tracker bearing apparatus of FIG. 14;

FIG. 16 is a schematic exploded front perspective view of the solar tracker bearing apparatus of FIG. 14;

FIG. 17 is a schematic right side or front perspective view of a second exemplary embodiment a solar tracker bearing apparatus of the present disclosure mounted to an upper mounting portion of a support post and rotatably supporting a support beam or torque tube beam, a portion of which is shown;

FIG. 18 is a schematic left side or back perspective view of the solar tracker bearing apparatus of FIG. 17, including portions of the support post and the torque tube beam;

FIG. 19 is a schematic front elevation view of the solar tracking bearing apparatus of FIG. 17, including portions of the support post and the torque tube beam;

FIG. 20 is a schematic side elevation view of the solar tracking bearing apparatus of FIG. 17, including portions of the support post and the torque tube beam;

FIG. 21 is a schematic top plan view of the solar tracking bearing apparatus of FIG. 17;

FIG. 22A is a schematic exploded perspective view of the solar tracker bearing apparatus of FIG. 17, including portions of the support post;

FIG. 22B is a schematic exploded perspective view of portions of the solar tracker bearing apparatus of FIG. 17, including a rotatable bearing assembly and a stationary saddle assembly;

FIG. 23 is a schematic front perspective view of a first bearing member of the rotatable bearing assembly of the solar tracker bearing apparatus of FIG. 17;

FIG. 24 is a schematic front elevation view of the first bearing member of FIG. 23;

FIG. 25 is a schematic back elevation view of the first bearing member of FIG. 23;

FIG. 26 is a schematic top plan view of the first bearing member of FIG. 23;

FIG. 27 is a schematic side elevation view of the first bearing member of FIG. 23;

FIG. 28 is a schematic front perspective view of a first saddle member of the stationary saddle assembly of the solar tracker bearing apparatus of FIG. 17;

FIG. 29 is a schematic front elevation view of the first saddle member of FIG. 28;

FIG. 30 is a schematic back elevation view of the first saddle member of FIG. 28;

FIG. 31 is a schematic bottom plan view of the first saddle member of FIG. 28;

FIG. 32 is a schematic side elevation view of the first saddle member of FIG. 28;

FIG. 33 is a schematic section view of the first saddle member of FIG. 28, as seen from a plane indicated by the line 33-33 in FIG. 29;

FIG. 34 is a schematic perspective view of a post cap of a connecting assembly of the solar tracker bearing apparatus of FIG. 17;

FIG. 35 is a schematic sectional view of the solar tracking bearing apparatus of FIG. 17, as seen from a plane indicated by the line 35-35 in FIG. 21;

FIG. 36 is a schematic right side or front perspective view of a third exemplary embodiment a solar tracker bearing apparatus of the present disclosure;

FIG. 37 is a schematic left side or back perspective view of the solar tracker bearing apparatus of FIG. 36;

FIG. 38 is a schematic front elevation view of the solar tracker bearing assembly of FIG. 36;

FIG. 39 is a schematic back elevation view of the solar tracker bearing assembly of FIG. 36;

FIG. 40 is a schematic top plan view of the solar tracker bearing apparatus of FIG. 36;

FIG. 41 is a schematic exploded front perspective view of the solar tracker bearing apparatus of FIG. 36;

FIG. 42 is a schematic exploded back perspective view of the solar tracker bearing apparatus of FIG. 36

FIG. 43 is a schematic front perspective view of a beam slot reinforcement member of the solar tracker bearing apparatus of FIG. 36;

FIG. 44 is a schematic front elevation view of the beam slot reinforcement member of FIG. 43;

FIG. 45 is a schematic front perspective view of a saddle reinforcement member of the solar tracker bearing apparatus of FIG. 36;

FIG. 46 is a schematic front elevation view of the saddle reinforcement member of FIG. 45;

FIG. 47 is a schematic top plan view of the saddle reinforcement member of FIG. 45; and

FIG. 48 is a schematic side elevation view of the saddle reinforcement member of FIG. 45.

### DETAILED DESCRIPTION

The present disclosure relates to a solar tracker bearing assembly or apparatus 200 for a solar tracker system 100 which permits and constrains a support beam such as a torque tube beam 150 of the system 100, to pivot or swing about an axis of rotation R. A plurality of solar tracker bearing apparatuses 200 are positioned at spaced apart locations along the torque tube beam 150 to pivotally support the torque tube beam 150. Advantageously, each of the plurality of solar tracker bearing apparatuses 200 includes a stationary saddle assembly 400 that rotatably supports and defines the axis of rotation R for a rotatable bearing assembly 300. That is, the rotatable bearing assembly 300 is confined to rotate about the axis of rotation R by the saddle assembly 400. In turn, the rotatable bearing assembly 300 supports the torque tube beam 150 and constrains the torque tube beam 150 to pivot or swing about the axis of rotation R. Thus, the axis of rotation R that the torque tube beam 150 is constrained to swing or pivot about is defined by the solar tracker bearing apparatus 200.

The solar tracker system 100 includes components that move or pivot about the axis of rotation R and other components which are stationary. The components of the solar tracker system 100 that pivot about the axis of rotation R are referred to as the table 110 of the solar tracker system and include: a) a frame 120 including the torque tube beam 150 and an array or plurality of module rails 130 affixed to the torque tube beam 150; b) a plurality of photovoltaic modules 190; c) the rotatable bearing assemblies 300 of the plurality of solar tracking bearing apparatuses 200 that support the torque tube 150 along its length; and d) associated brackets, clamps, fasteners, etc. that affix the photovoltaic modules 190 to the frame 120 and secure the components of the frame 120 together. Stationary components of the solar tracker system 100 include: a) a plurality of upright support posts 170 that support the saddles 400 of the solar tracer bearing apparatuses 200; b) the saddles 400 of the plurality of solar tracking bearing apparatuses 200; and c) an actuator/drive 180 that is coupled to the torque tube beam 150 and provides the motive power for pivoting the torque tube beam 150 and the table 110 though an angle of inclination AI. In one exemplary embodiment, the actuator/drive 180 is a slew motor that bisects the torque tube beam 150 along its length L at approximately a midpoint and is positioned on a support post 170 such that it drives the torque tube beam 150 and the table 110 about the axis of rotation R.

The plurality of solar tracker bearing apparatuses 200 are positioned along the torque tube beam 150 such that the bearing apparatuses 200 are substantially parallel to but spaced from a longitudinal axis LA of the torque tube beam 150. The individual axis of rotation R of each is the plurality of solar tracker bearing apparatuses 200 are thus substantially aligned to or coincident forming a single or combined axis of rotation CR. That is, the axis of rotation R of each of the solar tracker bearing apparatuses 200 are substantially coincident with the combined axis of rotation CR of the plurality of solar tracker bearing apparatuses 200. Hence, hereinafter when reference is made to the axis of rotation R of a given solar tracker bearing apparatus 200 it is to be understood that this axis of rotation R is part of and coincident with the combined axis of rotation CR of the plurality of solar tracker bearing apparatuses 200. Thus, reference will only be made to the axis of rotation R both for a specific solar tracker bearing apparatus 200 or the plurality of solar tracker bearing apparatuses 200.

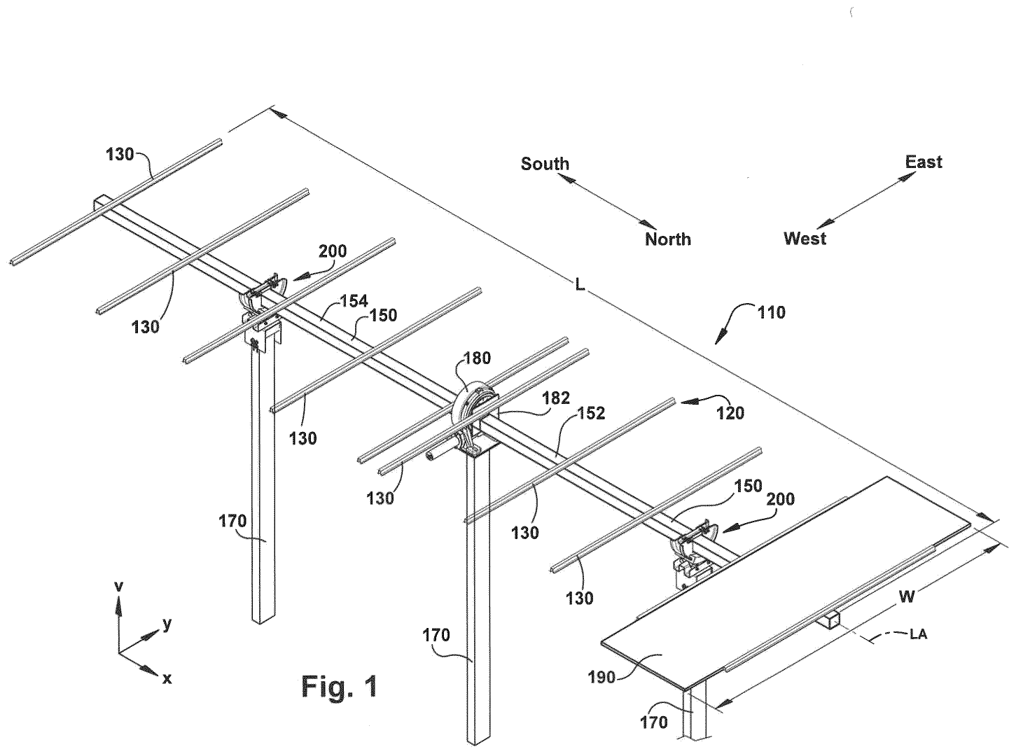

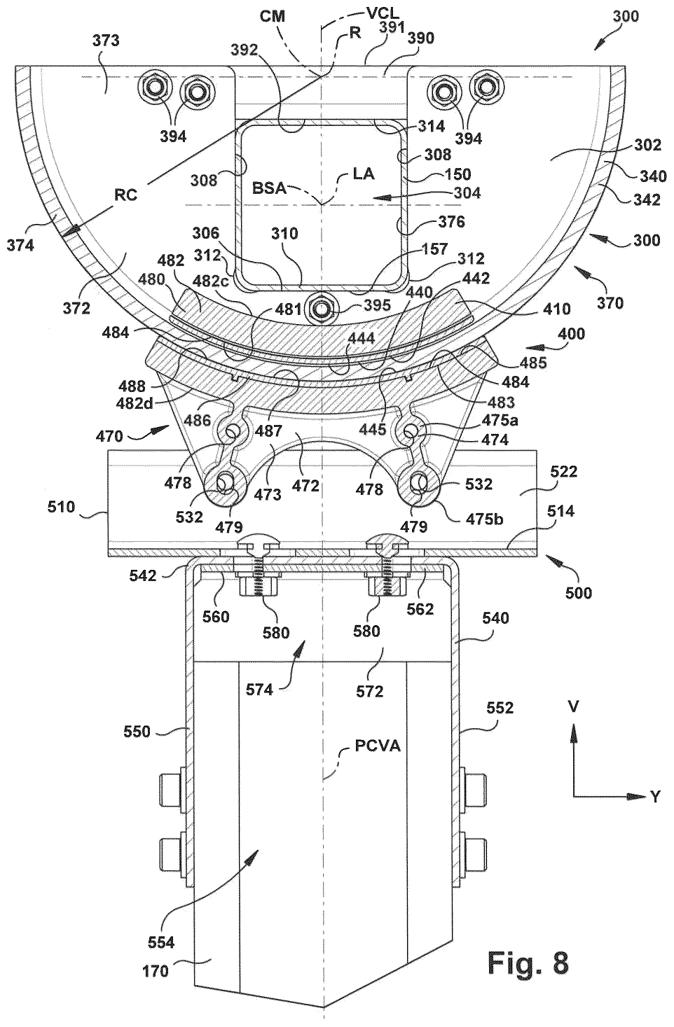

Much of the weight of the table 110 is accounted for by the plurality of photovoltaic modules 190 which are supported by the array or plurality of module rails 130 in a position that is generally vertically above the torque tube beam 150. A vertical direction V is shown FIG. 1. As such, a center of mass CM of the table 110 if calculated, will typically be found to be vertically aligned with the longitudinal axis of the torque tube beam 110, but positioned vertically above an upper wall 156 of the torque tube beam 110, that is, outside of and vertically above the torque tube beam 150. Of course, the exact position or location of the center of mass CM of the table 110 will depend on the configuration, and weight of the components comprising the table 110 of the solar tracker system 100. For proper balance and stability of the table 110 under varying load conditions (i.e., wind and snow loads, etc.), it is advantageous if the axis of rotation R of the plurality of solar tracker bearing apparatuses 200 passes through or passes as close as possible to the center of mass CM of the table 110. Since the axis of rotation R is determined by rotating path of travel of the rotatable bearing assemblies 300 of the plurality of solar tracker bearing apparatuses 200, the toque tube beam 150 which is disposed within a beam slot 306 of the rotatable bearing assemblies 300 is constrained to pivot or swing about the axis of rotation R. As best seen in FIG. 8, in one exemplary embodiment, the axis of rotation R is spaced from and outside of the walls of the torque tube beam 150. A periphery of the beam slot 306 is bounded by and defined by an upper wall 314 and axially spaced apart lower or bottom wall 310 wall and first and second laterally spaced apart side walls 308. The upper wall 314 of the beam slot 306 is defined by a lower wall 392 of a hold down bracket 390 of the rotatable bearing assembly 300. Extending through a center of the beam slot 306, as defined by beam slot walls 314, 310, 308 is a longitudinally or horizontally extending central beam slot axis BSA.

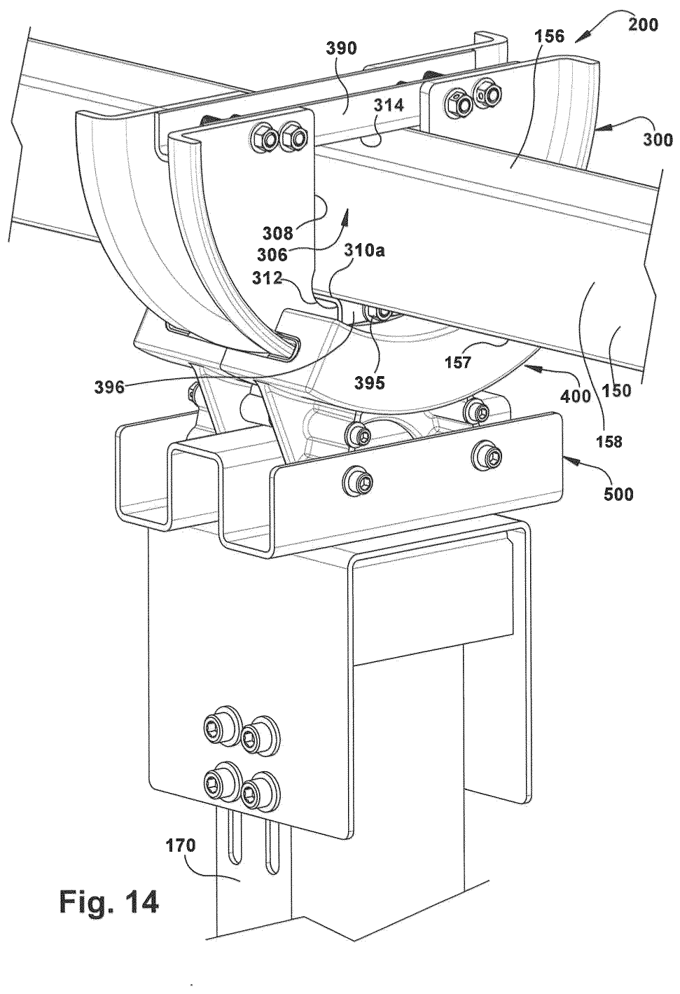

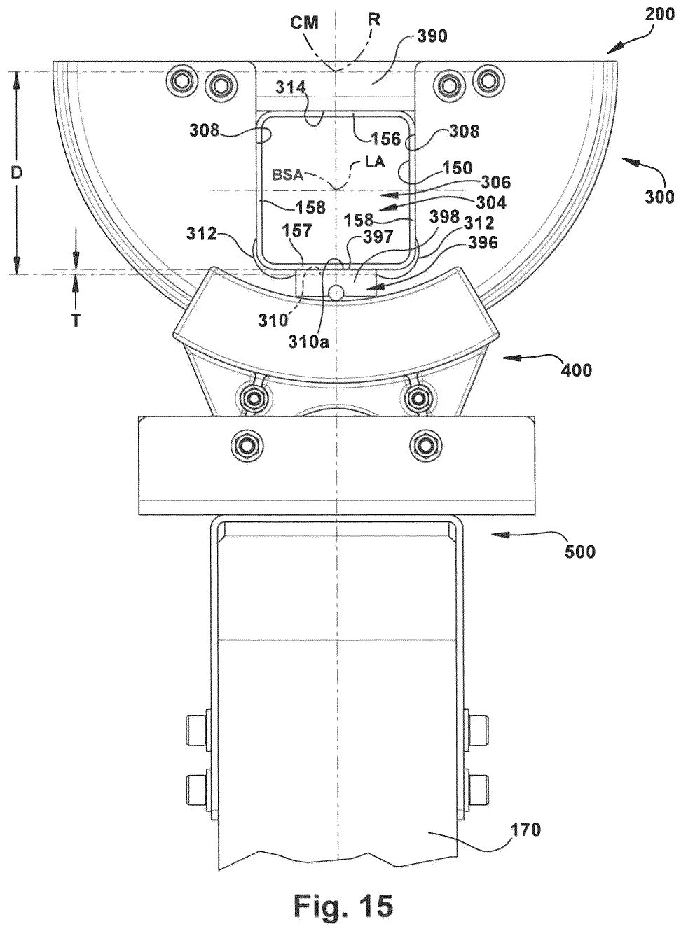

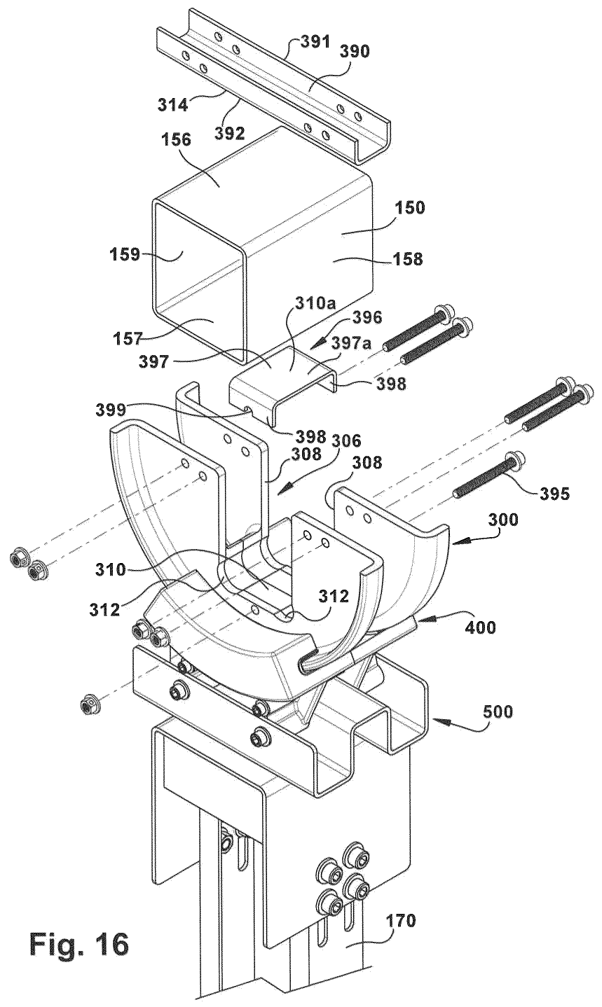

As best seen in FIG. 8, in one exemplary embodiment, the axis of rotation R of the rotatable bearing assembly is spaced from and is outside of the beam slot 306, as defined by beam slot walls 314, 310, 308 and the axis of rotation R is vertically aligned with and spaced above the central beam slot axis BSA. As best seen in FIG. 15, the beam slot 306 of the rotatable bearing assembly 300 has a depth D. Advantageously, as schematically depicted in FIG. 14-16, a shim 396 may be affixed to the rotatable bearing assembly 300 and a horizontal central portion 397 of the shim 396 extends through the beam slot 306. The horizontal central portion 397 of the shim 396 is adjacent to and overlies a bottom wall 310 of the beam slot 306 and bears against a lower wall 157 of the torque tube beam 150 thereby effectively vertically raising the torque tube beam 150 by a thickness T (FIG. 15) of the horizontal central portion 397 of the shim 396 with respect to the bottom wall 310 of the beam slot 306. That is, when the shim 396 is in place (as shown in FIGS. 14-16) the effective bottom wall 310a of the beam slot 306 is an upper surface 397a of the horizontal central portion 397 of the shim 396. Positioning the shim 396 adjacent the bottom wall 310 of the beam slot 310 advantageously adjusts or raises in the upward vertical direction V the center of mass CM of the table 110 to thereby more closely align the center of mass CM of the table 110 with the axis of rotation R of the solar tracker bearing apparatus 200. That is, without the use of a shim 396, e.g., FIG. 8, if the center of mass CM of the table 110 is vertically below the axis of rotation R of the plurality of solar tracker bearing apparatuses 200, the shim 396 having an appropriate thickness T of the horizontal central portion 397 is selected and installed in the beam slot 306 of the rotatable bearing assembly 300 of each solar tracker bearing apparatus 200. By doing so, the center of mass CM of the table 110 may advantageously be raised upwardly in the vertical direction V by the thickness T such that the center of mass CM of the table 110 is closer to alignment with the axis of rotation R of the plurality of solar tracker bearing apparatuses 200. As such and advantageously, the center of mass CM of the table 110 may be adjusted through the use of a selected shim 396, or the absence of a shim 396, in the beam slot 306 to change the vertical position of the center of mass CM of the table 110 and thereby come closer to the objective of having the axis of rotation R of the plurality of solar tracker bearing apparatuses 200 pass through or pass as close as possible to the center of mass CM of the table 110. The closer the axis of rotation R of the plurality of solar tracker bearing apparatuses 200 is to passing as close as possible to the center of mass CM of the table 110, the more nearly the table 110 is in balance.

As can be seen in a comparison of FIGS. 8 and 15, if no shim 396 is present in the beam slot 306 to elevate the torque tube beam 150 (and thereby elevate the center of mass CM of the table 110), the central beam slot axis BSA of the beam slot 306 is coincident with the longitudinal axis LA of the torque tube beam 150 (FIG. 8) and if the shim 396 is present in the beam slot 306 such that the torque tube beam 150 is elevated in the vertical direction V, the central beam slot axis BSA of the beam slot 306 is still coincident with the longitudinal axis LA of the torque tube beam 150 because the effective lower wall 310a of the beam slot 306 is defined by the upper surface 397a of the horizontal central surface 397 of the shim 396. In one exemplary embodiment, the thickness T of the shim 396 is 0.120 in.

As mentioned previously, the solar tracker system 100 includes the frame 120 comprising the torque tube beam 150 and the array of orthogonally oriented module rails 130 which are affixed to the torque tube beam 150 by brackets 160. Fasteners may also be used in place of or in addition to brackets. The plurality of photovoltaic panels or modules 190 (only an exemplary one of which is shown in FIG. 1) are supported between adjacent pairs of the module rails 130. A typical size of a photovoltaic panel 190 is one meter by two meters. Thus, a width W of the table 110 of the solar tracker system 100, in one exemplary embodiment, is approximately two meters.

A length L of the table 110 of the solar tracker system 100 is primarily determined by an extent or length of the torque tube beam 150. In one exemplary embodiment, the torque tube beam 150 is comprised of a plurality of predetermined lengths or segments, i.e., 40 foot segments, which are coupled together in an end to end configuration by collars. For simplicity, in FIG. 1, a shortened, schematic version of the torque tube beam 150 is shown. In one exemplary embodiment, the torque tube beam 150 includes a first portion 152 and a second portion 154 extending from either side of the actuator/controller mechanism, namely, the slew drive 180. That is, the slew drive 180, which rotates the torque tube beam 150, bisects or interrupts the torque tube beam 150 at or near a longitudinal center along the length L of the beam 150. The first portion 152 of the torque tube beam 150 extends from a first coupler 182 affixed to one side of the slew drive 180, while the second portion 154 of the torque tube beam 150 extends from a second coupler (not shown) affixed to an opposite side of the slew drive 180. As noted above, the schematic representation of the solar tracking system 100 depicted in FIG. 1 includes a relatively short toque tube beam 150. In reality, the length of the torque tube beam 150 may include five 40 foot beam segments comprising the first portion 152 of the torque tube beam 150 and five 40 foot beam segments comprising the second portion 154 of the torque tube beam 150 for a total length of approximately 400 feet and an ability to over 100 photovoltaic modules 190.

The plurality module rails 130 are typically oriented in an east-west orientation and the supported photovoltaic modules 190, which may extend beyond the ends of modules rails 130, define the width W of the table 110, while the torque tube beam 150 is typically oriented in a north-south orientation and defines the length L of the table 110. Each of the plurality of module rails 130 are affixed to the torque tube beam 150 by a support bracket 160. The torque tube beam 150 extends in a north-south direction, while the plurality of module rails 130 extend in an east-west direction 120. In one exemplary embodiment, the torque tube beam 150 is substantially square in cross section, having a hollow interior, and is centered about a torque tube beam longitudinal axis LA. In one exemplary embodiment the torque tube beam 150 is approximately 100 mm. by 100 mm. (approximately 4 in. by 4 in.).

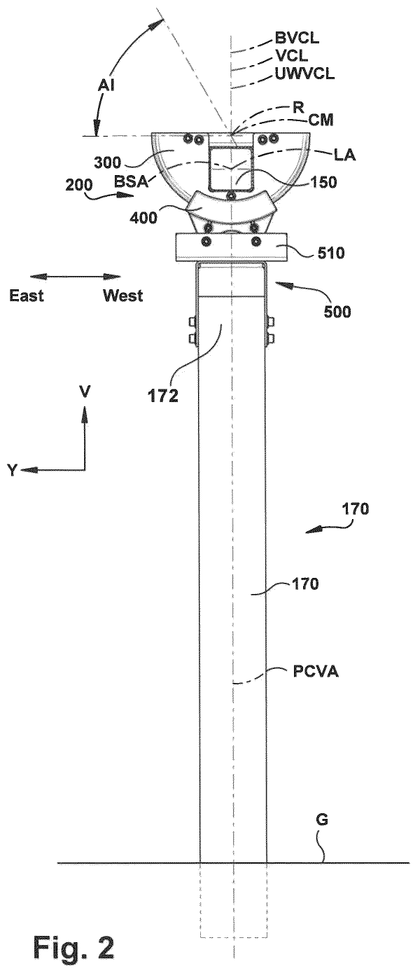

The solar tracker system 100 further includes the plurality of spaced apart aligned upright support posts 170 which are anchored to or anchored in a substrate G (FIG. 2), such as the ground or a roof of a building. To minimize torque load on the posts 170, the posts 170 typically extend upwardly in the vertical direction V. The plurality of upright support posts 170 are aligned along an extent or length of the torque tube beam 150 and are spaced apart, typically uniformly, along the length of the torque tube beam 150. Each post 170 includes a center line or central vertical axis PCVA (FIG. 2) that extends through an approximate cross sectional center of the support post 170. Ideally, if the support post 170 is installed properly, the post center line or central vertical axis PCVA would be vertical. However, due to terrain difficulties and other installation issues, it may be the case that the post center line PCVA is slightly off vertical, resulting in one type of misalignment condition. Further, ideally, each of the plurality of support posts 170 would be positioned such that a vertical center line CLP of each support post 170 would intersect the longitudinal axis LA of the torque tube beam 150. Again, however, due to terrain difficulties and other installation issues, it may be the case that the post center line PCVA does not intersect the longitudinal axis LA of the torque tube beam 150, resulting in another type of misalignment condition. Moreover, each support post 170 includes a pair of spaced apart side walls 174. Each of the side walls 174 include a pair of vertically oriented mounting slots 176. Ideally, each of the plurality of support posts 170, when installed, would have the side walls 174 oriented such that they are parallel to the longitudinal axis LA of the torque tube beam 170. Again, however, due to terrain difficulties and other installation issues, it may be the case that the post side wall 174 that include the mounting slots 176 are off from being parallel with the longitudinal axis LA of the torque tube beam 170, resulting in yet another type of misalignment condition. Advantageously, the solar tracker bearing apparatus 200 of the present disclosure provides for mounting adjustability in the mounting and orientation of the solar tracking bearing apparatus 200 to an upper mounting portion 172 of the support post 170 to account for several common misalignment conditions. That is, a connecting structure or assembly 500 and a lower coupling portion 402 of a saddle assembly 400 of the solar tracker bearing apparatus 200 have sufficient degrees of freedom or ranges of adjustability when coupled to the upper mounting portion 172 of the support post 170 to account for several of such misalignment conditions (within limits of the ranges of adjustability provided by the connecting assembly 500 and the saddle assembly 400).

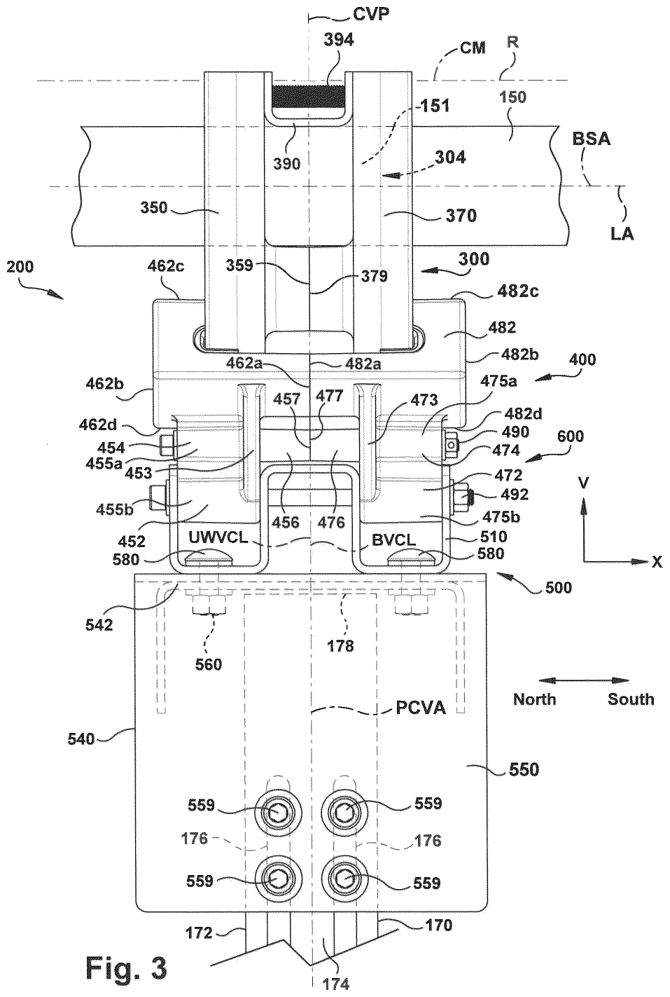

As best seen in FIGS. 3-9, mounted to the upper mounting portion 172 of each support post 190 is the solar tracker bearing apparatus 200 which receives and rotatably supports a longitudinally extending portion of the torque tube beam 150. As mentioned previously, the solar tracker system 100 further includes the controller mechanism, such as the slew motor 180, which is coupled to the torque tube beam portions 152, 154 and acts to change an angle of inclination AI (FIG. 2) of the table 110 and thereby adjust light receiving surfaces of the plurality of photovoltaic modules 190 to track the movement of the sun across the sky from east to west so that the photovoltaic modules 190 are maximally exposed to the sun to throughout the day, within the limits or the range of the angle of inclination AI as provided by the slew motor 180 and the configuration of the table 110. It should be understood that the angle of inclination AI shown in FIG. 2 represent a maximum rotational or pivotal movement of a rotatable bearing assembly 300 of the solar tracker bearing apparatus 200 about its axis of rotation R in one direction (shown in dashed line in FIG. 2 as a clockwise rotation about the axis of rotation R) with respect to a home position of the rotatable bearing assembly 300 (shown in solid line). The rotatable bearing assembly 300 may also rotate or pivot in an opposite direction, a counterclockwise direction, an angular movement or rotation equal to angle of inclination AI.

### Solar Tracker Bearing Apparatus 200

As noted above, the number of solar tracker bearing apparatuses 200 in a solar tracker system 100 will depend on the number of upright support posts 170. Typically each support post 170 will include a solar tracker bearing apparatus 200 affixed to the upper mounting portion 172 of the post 170 and, thus, the torque tube beam 150 will be supported along its length or extent by a plurality spaced apart bearing apparatuses 200. Each bearing apparatus 200 will receive and provide bearing support to a longitudinally extending portion 151 of the torque tube beam 150 and each bearing apparatus 200 thus will support a portion of the total weight of the torque tube beam 150, the frame 120 and the plurality of photovoltaic modules 190. Typically, the torque tube beam 150 will be oriented in a generally north-south horizontal position such that as the table 110 pivots, the angle of inclination AI of the table 110 changes to track the sun across the sky from east to west to keep the light receiving surfaces of the plurality of photovoltaic modules 190 aimed, to the extent possible, at the sun to maximize sunlight exposure of the modules 190 throughout the day.

Each solar tracker bearing apparatus 200 of the plurality of solar tracker bearing apparatuses is substantially identical and includes the rotatable bearing assembly 300 supported for pivoting or rotation about the axis of rotation R by the stationary saddle assembly 400. The rotatable bearing assembly 300 of the solar tracker bearing apparatus 200 is pivotal along a single axis or axis of rotation R. Thus, the bearing apparatus 200 may be referred to as a single axis bearing assembly or single axis tracker. For simplicity purposes, reference to the solar tracker bearing apparatus 200 will be understood to apply to each of the plurality of solar tracker bearing apparatuses 200 utilized in a specific solar tracker system 100. Further, the axis of rotation R of the respective rotatable bearing assemblies 300 of each solar tracker bearing apparatus 200 of the solar tracker assembly 100 is substantially aligned or coincident and is spaced from and parallel to the longitudinal axis LA of the torque tube beam 150. As used herein, a direction X (or X direction) is a horizontal direction that is orthogonal to the vertical direction V and is substantially parallel to the longitudinal axis LA of the torque tube beam 150 and is substantially parallel to the axis of rotation R of each of the solar tracker bearing apparatuses 200. Assuming that the torque tube beam 150 extends in a generally north-south horizontal direction as mentioned above, the direction X as used herein will be a north-south horizontal direction. Thus, the direction X is parallel to the axis of rotation R of the rotatable bearing assembly 300 of any given solar tracker bearing apparatus 200. Similarly, as used herein, a direction Y (or Y direction) is a horizontal direction that is orthogonal to the vertical direction V and is substantially orthogonal to the longitudinal axis LA of the torque tube beam 150 and is substantially orthogonal to the axis of rotation R of each of the solar tracker bearing assemblies 200, that is, the direction Y as used herein will be an east-west horizontal direction.

In one exemplary embodiment, the solar tracker bearing apparatus 200 of the present disclosure includes the rotatable bearing assembly 300 supported for rotation about the axis of rotation R by the stationary saddle assembly 400. The solar tracker bearing apparatus 200 further includes the connecting assembly 500 for adjustably securing the saddle assembly 400 to the upper mounting portion 172 of the post 170. In one exemplary embodiment, the connecting assembly 500 affixes a lower coupling portion 402 of the saddle assembly 400 to the upper mounting portion 172 of the support post 150.

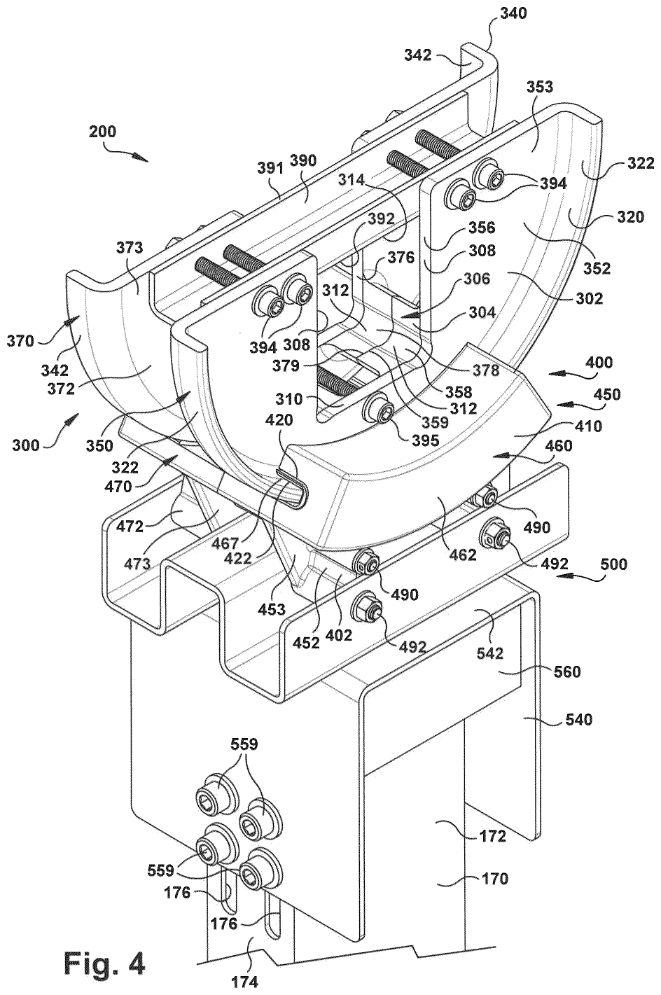

As best seen in FIGS. 4-6, in one exemplary embodiment, the rotatable bearing assembly 300 includes a central portion 302 and first and second spaced apart arcuate peripheral portions 320, 340. The central portion 302 of the bearing assembly 300 includes a channel 304 defining the beam slot 306 for receiving the torque tube beam 150. The beam slot 306 includes spaced apart vertical side walls 308 and the horizontally extending lower wall 310 for receiving and abutting the lower wall 157 and the horizontally extending upper wall 314 abutting the upper wall 156 of the square cross sectional shape of the torque tube beam 150. The first peripheral portion 320 of the bearing assembly 300 includes a first arcuate rim bearing 322 and the second peripheral portion 340 includes a second arcuate rim bearing 342. The first and second rim bearings 322, 342 are spaced apart as viewed in an axial direction, that is, as measured or viewed along the axis of rotation R of the rotatable bearing assembly 300 (stated another way, spaced apart as measured in the horizontal direction X) and are centered about the axis of rotation R. Further, the first and second rim bearings 322, 342, as viewed with respect to the axis of rotation R, have the same radius or radius of curvature RC (shown schematically in FIG. 8), that is, the first and second rim bearings 322, 342 would lie on the surface of a right angle or right cylinder extending along and centered about the axis of rotation R and having a radius RC. To facilitate a flush fit between the portion 151 of the torque tube beam 150 received in the beam slot 306 and, specifically, to facilitate a flush fit between side walls 158 of the torque tube beam portion 151 and the opposing side walls 308 of the beam slot 306 and between the lower wall 157 of the torque tube beam portion 151 and the bottom wall 310 of the beam slot 306 and to facilitate ease of removal of the torque tube beam portion 151 from the beam slot 306, there are double radius recesses 312 forming the corner transitions between the opposing side walls 308 and the bottom wall 310 of the beam slot 306.

In one exemplary embodiment, the stationary saddle assembly 400 includes the lower coupling portion 402, adapted to be affixed to the connecting assembly 500, and an upper bearing portion 410, for pivoting support of the rotatable bearing assembly 300. The upper support portion 410 of the saddle assembly 400 includes a first arcuate slot 420 and a second arcuate slot 440. The first arcuate slot 420 includes a first arcuate bearing race 422 and the second arcuate slot 440 includes a second arcuate bearing race 442. The first and second arcuate bearing races 422, 442 are spaced apart as viewed in an axial direction, that is, as measured or viewed along the axis of rotation R of the rotatable bearing assembly 300 (stated another way, spaced apart as measured in the horizontal direction X) and are centered about the axis of rotation R. Further, the first and second arcuate bearing races 422, 442, as viewed with respect to the axis of rotation R, have the same radius or radius of curvature RC as the first and second rim bearings 322, 342. That is, the first and second arcuate bearing races 422, 442 would lie on the surface of a right cylinder extending along and centered about the axis of rotation R and having a radius RC. The first arcuate bearing race 422 slidably supports the first arcuate rim bearing 322 of the rotatable bearing assembly 300 and the second arcuate bearing race 442 slidably supports the second arcuate rim bearing 342 of the rotatable bearing assembly 300 such that the arcuate or pivoting movement of the rotatable bearing assembly 300 is centered about the axis of rotation R.

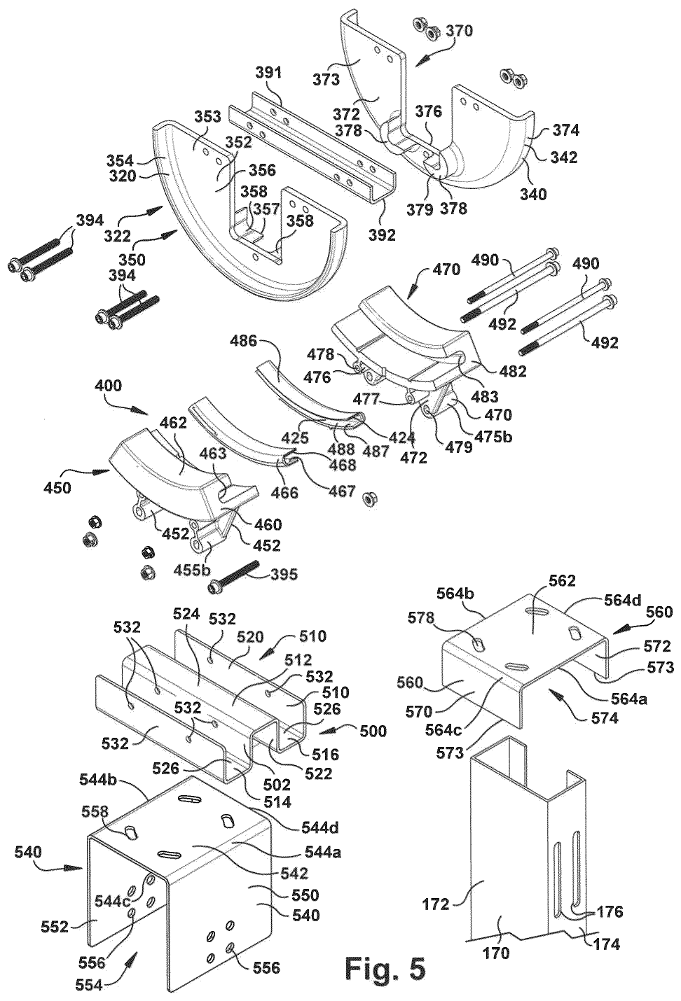

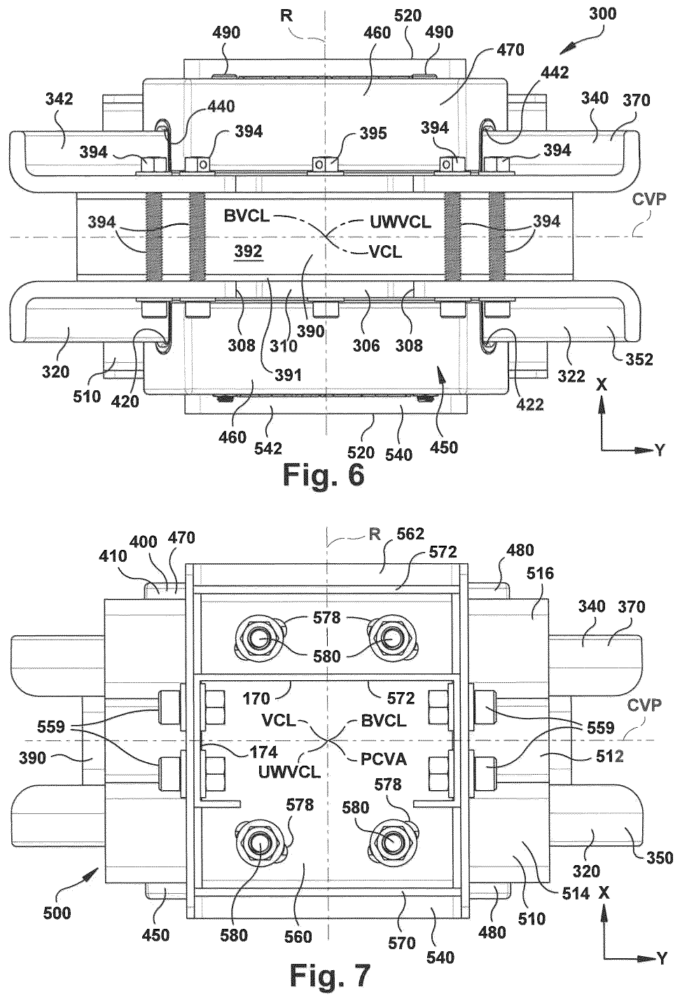

As best seen in FIG. 5, in one exemplary embodiment, the rotatable bearing assembly 300 and the stationary saddle assembly 400 of the solar tracker bearing apparatus 200 are both two-part assemblies that are symmetric about a central vertical plane CVP (FIGS. 3, 6 and 7) extending through the solar tracker bearing apparatus 200. The central vertical plane CVP of the solar tracker bearing apparatus 200 is parallel to and aligned with the central vertical axis PCVA of the support post 170 and extends orthogonally to and is intersected by the axis of rotation R of the rotatable bearing assembly 300, that is, the central vertical plane CVP of the solar tracker bearing apparatus 200 extends in the vertical direction V. The central vertical plane CVP of the solar tracker bearing apparatus 200 includes a vertical center line VCL (FIGS. 6 and 7) of the apparatus 200 that intersects and is orthogonal to the axis of rotation R of the rotatable bearing assembly 300. In one exemplary embodiment, the rotatable bearing assembly 300 includes first and second bearing members 350, 370 and the saddle assembly 400 includes first and second saddle members 450, 470. Because the first and second bearing members 350, 370 are symmetrical about the central vertical plane CVP, advantageously, the members 350, 370 are identical, leading to significant efficiencies in the manufacture of the rotatable bearing assembly 300 and reducing inventory requirements. Similarly, because the first and second saddle members 450, 470 are symmetrical about the central vertical plane CVP, advantageously, the members 450, 470 are identical, leading to significant efficiencies in the manufacture of the saddle assembly 300 and reducing inventory requirements.

### Rotatable Bearing Assembly 300

The first bearing member 350 of the rotatable bearing assembly 300 is generally semicircular including a generally planar central region 352 and a laterally extending peripheral rim 354. The planar central region 352 is substantially parallel to but spaced laterally from the central vertical plane CVP of the solar tracker bearing apparatus 200. The central region 352 includes a generally U-shaped cut-out 356. Extending laterally from the planar central region 352 adjacent the U-shaped cut out 356 are a pair of projections 358. The pair of projections 358 extend laterally from the central portion in a direction opposite the peripheral rim 354 and form a portion of the U-shaped cut out 356. Similarly, the second bearing member 370 is generally semicircular including a generally planar central region 372 and a laterally extending peripheral rim 374. The planar central region 372 is substantially parallel to but spaced laterally from the central vertical plane CVP of the solar tracker bearing apparatus 200. The central region 372 includes a generally U-shaped cut-out 376. Extending laterally from the planar central region 352 adjacent the U-shaped cut-out 376 are a pair of projections 378. The pair of projections 378 extend laterally from the central portion in a direction opposite the peripheral rim 374 and form a portion of the U-shaped cut-out 376.

The central portion 302 of the rotatable bearing assembly 300 is defined by the spaced apart planar central regions 352, 372, along with the pairs of projections 358, 378, of the first and second bearing members 350, 370. The beam slot 306 of the rotatable bearing assembly 300 receives and supports the torque tube beam 150 is defined by the U-shaped cut-outs 356, 376 of the first and second bearing members 350, 370. Advantageously, because of the respective pairs of projections 358, 378 extend laterally from the central portions 352, 372 and, thus, function to space apart the central portions 352, 372 of the first and second bearing members 350, 370, an axial extent of the beam slot 306, that is, an extent of the beam slot 306 as measured with respect to the axis of rotation R (or as measured along the horizontal direction X) is large. This advantageously provides for increased area of support and thus increased stability in support of the torque tube beam 150 as it is received in the beam slot 306 and is pivotally supported by the bearing assembly 300. The generally U-shaped hold down bracket 390 is disposed between respective upper portions 353, 373 of the central regions 352, 372 of the first and second bearing members 350, 370. The hold down bracket 390 functions to both secure a portion 151 of the torque tube beam 150 disposed within the beam slot 306 and laterally space apart the central portions 352, 372 of the first and second bearing members 350, 370. The torque tube beam 150 is confined from movement within the beam slot 306 by beam slot bottom wall 310, a pair of beam slot side walls 308 and the upper wall 314 defined by the lower or bottom wall or end 392 of the hold down bracket 390.

The first and second bearing members 350, 370 are secured via four fasteners 394 that extend in the direction X though aligned apertures of the first and second bearing members 350, 370 and aligned horizontal apertures in the hold down bracket 390 which functions to laterally space apart the first and second bearing members 350, 370. It should be understood, of course, that if a shim 396 is utilized and the position of the torque tube beam 150 within the beam slot 306 is raised, a different configuration of the hold down bracket 390 will have to be utilized to abut the upper wall 156 of the torque tube beam 150 and still allow the aligned apertures of the hold down bracket 390 to receive the four fasteners 394 that extend though the hold down bracket 390 and the aligned apertures of the first and second bearing members 350, 370. The pair of projections 358, 378 also function to laterally space the first and second bearing members 350, 370 and horizontal surfaces of the projections 358, 378 form portions of the bottom wall 310 of the beam slot 306. Facing surfaces 357, 377 of the respective pairs of projections 358, 378 abut and function to space apart the respective planar central regions 352, 372. The facing surfaces 359, 379 of the respective pairs of projections 358, 378 are positioned along and are coincident with the central vertical plane CVP of the solar tracker bearing apparatus 200.

A fifth fastener 395 extends to align apertures of the central portions 352, 372 of the first and second bearing members 350, 370 in the region of the projections 358, 378 to additionally secure the first and second bearing members 350, 370. Additionally, to the extent a shim 396 is used to raise the center of mass CM of the table 110, the fifth fastener 395 extends through aligned inverted U-shaped recesses or openings 399 formed in lower edges of vertically extending legs 398 of the shim 396 to affix the shim 396 to the first and second bearing members 350, 370 such that the horizontal central portion 397 is disposed against and overlies the bottom wall 310 of the beam slot 306. The upper surface 397a of the horizontal central portion 397 of the shim 396 in the beam slot 306 bears against the lower wall 157 of the torque tube beam 150 and thereby raises the torque tube beam 150 in the vertical direction V by a thickness T (FIG. 15) of the horizontal central portion 397 of the shim 396 and thus raises the center of mass CM of the table 110 by the same thickness T of the horizontal central portion 397 of the shim 396. In one exemplary embodiment, the fasteners 394, 395, as well as other fasteners referred to below, may be two-part threaded fasteners including a threaded bolt and threaded nut combination wherein the head of the bolt includes a hex drive socket for driving by a hex driver. As would be recognized by one of skill in the art, other types of fasteners may be utilized instead of or in combination with the two-part threaded fasteners shown in the drawings.

The laterally extending peripheral rim 354 defines the first arcuate rim bearing 322 of the first peripheral portion 320 of the bearing assembly 300, while the laterally extending peripheral rim 374 defines the second arcuate rim bearing 342 of the second peripheral portion 340 of the bearing assembly 300. Advantageously, since the peripherally rims 354, 374 extend away from the respective central regions 352, 372 of the first and second bearing members 250, 370, an axial distance, that is, a distance as measured along the axis of rotation R, between the first and second arcuate rim bearings 322, 342 is large. This large axial distance between bearing engagement surfaces of the rim bearings 322, 342 of the bearing assembly 300 and the bearing engagement surfaces of the first and second bearing races 422, 442 of the saddle assembly 400 advantageously provides for improved bearing support and improved stability for the bearing assembly 300 as it rotates with respect to the saddle assembly 400 about the axis of rotation R. In one exemplary embodiment, as measured with respect to the axis of rotation R, the angular or arcuate extent of the first and second rim bearings 322, 342 is approximately 181.75 degrees. If the arcuate extent of the first and second rim bearings 322, 342, was exactly 180 degrees, then the axis of rotation R would pass through a point along an upper end 391 of the hold down bracket 390 and would be centered between the opposing side walls 308 of the beam slot 306. Since, in the exemplary embodiment, the arcuate extent of the first and second rim bearings 322, 342 is slightly greater than 180 degrees, as can best be seen in FIGS. 3 and 8, the axis of rotation R passes through a point somewhat vertically below the upper end 391 of the hold down bracket 390 and would be centered between the opposing side walls 308 of the beam slot 306. If, in another exemplary embodiment, the arcuate extent of the first and second rim bearings 322, 342 is somewhat less than 180 degrees, the axis of rotation R would pass through a point somewhat vertically above the upper end 391 of the hold down bracket 390 and would be centered between the opposing side walls 308 of the beam slot 306. In one exemplary embodiment, as shown, for example, in FIG. 8, without the use of the shim 396, the axis of rotation R is approximately 2.99 inches vertically above the longitudinal axis of the torque tube beam 150 and the same distance vertically above the central axis BSA of the beam slot 306. In one exemplary embodiment, as measured with respect to the axis of rotation R, the angular or arcuate extent of the first and second bearing races 422, 442 of the saddle assembly 400 is approximately 60 degrees. Accordingly, in one exemplary embodiment, the angle of inclination AI of the solar tracker bearing apparatus 200 is approximately +/−60 degrees (or 120 degrees of total angular pivot of the table 110).

### Saddle Assembly 400

As best seen in FIGS. 3-5 and 10, the saddle assembly 400 includes a lower coupling portion 402 and the upper bearing portion 410. As noted above, the upper bearing portion 410 includes the first arcuate slot 420 and the second arcuate slot 440. The first arcuate slot 420 includes the first arcuate bearing race 422 and the second arcuate slot 440 includes the second arcuate bearing race 442. The first and second arcuate bearing races 422, 442 are spaced apart as viewed in an axial direction, that is, as measured or viewed along the axis of rotation R of the rotatable bearing assembly 300 (stated another way, spaced apart as measured in the horizontal direction X) and are centered about the axis of rotation R. The first arcuate bearing race 422 slidably supports the first arcuate rim bearing 322 of the rotatable bearing assembly 300 and the second arcuate bearing race 442 slidably supports the second arcuate rim bearing 342 of the rotatable bearing assembly 300 such that the arcuate or pivoting movement of the rotatable bearing assembly 300 is centered about the axis of rotation R.

The first arcuate bearing race 422, when viewed in cross section is a horizontally oriented U-shaped surface 423, with the opening of the U-shaped surface 423 facing toward the vertical center line VCL of the solar tracker bearing apparatus 200 or, stated another way, facing toward the central vertical plane CVP of the apparatus 200. The U-shaped surface 423 of the first arcuate bearing race 422 includes an arcuate inner bearing surface or race 424 and a radially spaced apart arcuate outer bearing surface or race 425, both centered about the axis of rotation R of the rotatable bearing assembly 300 and the inner arcuate bearing race 424 being closer to the axis of rotation R than the arcuate outer bearing race 425. The inner bearing race 424 providing sliding bearing support for an arcuate inner surface 324 of the first arcuate rim bearing 322 and the outer bearing race 425 providing sliding bearing support for an arcuate outer surface 325 of the first arcuate rim bearing 322.

The second arcuate bearing race 442, when viewed in cross section is a horizontally oriented U-shaped surface 443, with the opening of the U-shaped surface 443 facing toward the vertical center line VCL of the solar tracker bearing apparatus 200 or, stated another way, facing toward the central vertical plane CVP of the apparatus 200. The U-shaped surface 443 of the first arcuate bearing race 442 includes an arcuate inner bearing surface or race 444 and a radially spaced apart arcuate outer bearing surface or race 445, both centered about the axis of rotation R of the rotatable bearing assembly 300 and the inner arcuate bearing race 444 being closer to the axis of rotation R than the arcuate outer bearing race 445. The inner bearing race 444 providing sliding bearing support for an arcuate inner surface 344 of the second arcuate rim bearing 342 and the outer bearing race 445 providing sliding bearing support for an arcuate outer surface 345 of the second arcuate rim bearing 342.

In one exemplary embodiment, the saddle assembly 400 is a two piece assembly comprising the first and second saddle members 450, 470 which are identical and symmetric about the central vertical plane CVP of the solar tracker bearing apparatus 200. The first saddle member 450 includes an upper bearing region 460 and a lower support region 452. The lower support region 452 of the first saddle member 450 includes a downwardly or vertically extending generally planar flange 453. The vertical planar flange 453 includes a pair of bosses 454 extending laterally in a direction away from the central vertical plane CVP of the solar tracker bearing apparatus 200. Each of the pair of bosses 454 includes an upper cylindrical sleeve 455a and a lower cylindrical sleeve 455b, each of the sleeves 455a, 455b includes a horizontally extending aperture through the respective sleeves. The lower support region 452 of the first saddle member 450 also includes a pair of projections 456 extending laterally from the flange 453 in a direction toward the central vertical plane CVP. The pair of projections 456 include apertures that are aligned with the apertures of the upper cylindrical sleeve 455a, thus, providing a pair of horizontal throughbores 458 through the lower support region 452 of the first saddle member 450.

The second saddle member 470 includes an upper bearing region 480 and a lower support region 472. The lower support region 472 of the second saddle member 470 includes a downwardly or vertically extending generally planar flange 473. The vertical planar flange 473 includes a pair of bosses 474 extending laterally in a direction away from the central vertical plane CVP of the solar tracker bearing apparatus 200. Each of the pair of bosses 474 includes an upper cylindrical sleeve 475a and a lower cylindrical sleeve 475b, each of the sleeves 475a, 475b includes a horizontally extending aperture through the respective sleeves 475a, 475b. The lower support region 472 of the second saddle member 470 also includes a pair of projections 476 extending laterally from the flange 473 in a direction toward the central vertical plane CVP. The pair of projections 476 include apertures that are aligned with respective apertures of the upper cylindrical sleeve 475a of the pair of bosses 474. This alignment of respective apertures provides a pair of horizontal throughbores 478 through the lower support region 472 of the second saddle member 470.

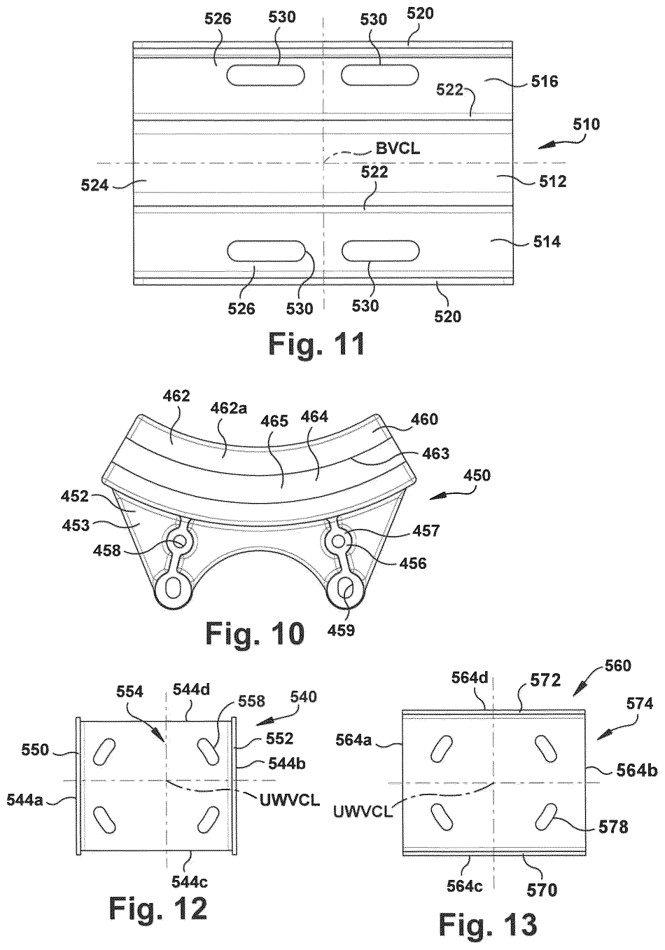

When the first and second saddle members 450, 470 are assembled, a pair of horizontally extending fasteners 490 extend through the aligned horizontal throughbores 458, 478 of the respective lower support regions 452, 472 of the first and second saddle member 450, 470 to secure the first and second saddle members 450, 470 together. Facing surfaces 457, 477 of the respective pairs of projections 456, 476 abut and function to axially space apart the respective planar flanges 453, 473 of the first and second saddle members 450, 470. The flanges 453, 473 are also axially spaced apart by an inverted U-shaped channel 512 of a horizontally oriented W brace 510 of the connecting assembly 500. The inverted U-shaped channel 512 of the horizontally oriented W brace 510, like the flanges 453, 473 of the first and second saddle members 450, 470 extend in the horizontal direction Y. The W brace 510 includes a pair of vertically oriented outer side walls 520 and a pair of vertically oriented inner side walls 522. A pair of horizontal fasteners 492 extend in the direction X through aligned apertures formed in the outer and inner side walls 520, 522 of the W brace 510 and the apertures extending through the respective the lower cylindrical sleeves 455b of lower support region 452 of first saddle member 450 and the lower cylindrical sleeves 475b of lower support region 472 of second saddle member 470 to secure the saddle assembly 400 to the W brace 510 and additionally secure the first and second saddle members 450, 470 together. As best seen in FIGS. 8 and 10, the apertures through the lower cylindrical sleeves 455b, 475b of the first and second saddle members 450, 470 constitute arched or arcuate slots 459, 479. The arcuate slots 459, 479 are concave with respect to the vertical center line VCL of the bearing assembly 200. Advantageously, the arcuate slots 459, 479 of the first and second saddle members 450, 470 provide for a tilt adjustability of the saddle member 400 with respect to the support post 170 to account for a misalignment condition referred to as a post tilt condition, as explained below. The lower support regions 452, 472 of the first and second saddle member 450, 470, as assembled, comprise the lower coupling portion 402 of the saddle assembly 400. Additionally, as the W brace 510 is assembled to the saddle assembly 400 and the saddle assembly 400 rotatably supports the bearing assembly 300, an assembled combination of the W brace 510 of the connecting assembly 500, the saddle assembly 400 and the rotatable bearing assembly 300 will be referred to as the assembled combination 600.

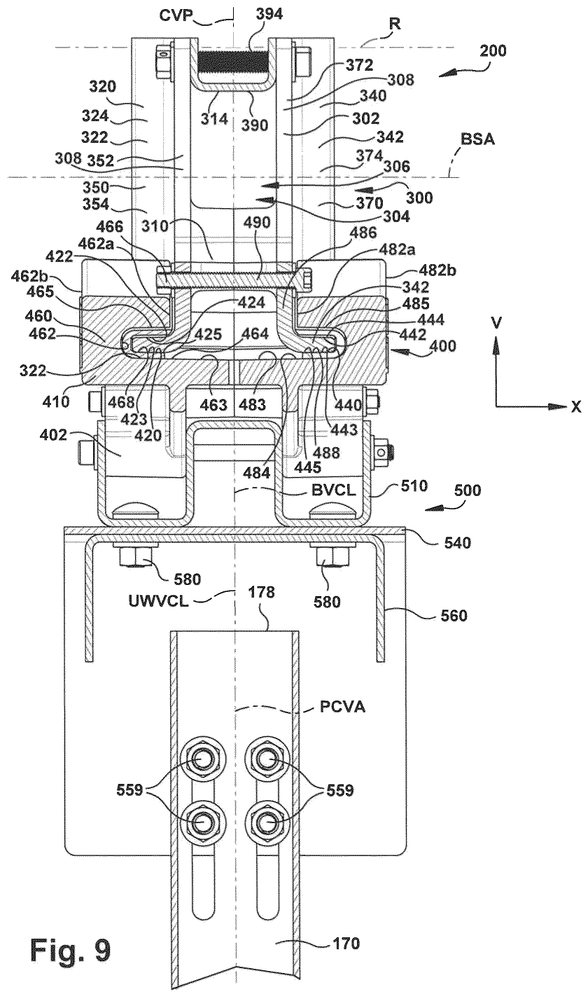

As best seen in FIGS. 8 and 9, in one exemplary embodiment, the upper bearing region 460 of the first saddle member 450 includes an arcuate body 462 which is generally rectangular in cross section including an inner wall 462a, an axially spaced apart outer wall 462b, an upper surface 462c and a radially spaced apart lower surface 462d. By radially spaced apart it is meant that the upper and lower surfaces 460c, 460d are spaced apart as measured along a radius line extending vertically downwardly from the axis of rotation R of the bearing apparatus 200, with the upper surface 460c being closer to the axis of rotation R. The upper surface 460c of the arcuate body 462 includes a J-shaped opening 463, as viewed in cross section FIG. 9). An interior region 464 of the J-shaped opening 463 defines a U-shaped slot 465. A low friction, durable U-shaped insert 466 is fixedly positioned in the U-shaped slot 465. The low friction insert 466 includes a U-shaped slot 467, as viewed in cross section. The U-shaped slot 467 of the insert 466 defines the U-shaped surface 423 and the inner and outer bearing races 424, 425 of the first bearing race 422 which slidingly receives the first arcuate rim bearing 322 of the first peripheral portion 320 of the rotatable bearing assembly 300. Stated another way, the U-shaped slot 467 of the insert 466 defines a first journal bearing race 468, comprising the first bearing race 422 of the upper bearing portion 410 of the saddle assembly 400 and the U-shaped slot 467 of the insert 466 defines the first arcuate slot 420 of the upper bearing portion 410 of the saddle assembly 400.

In one exemplary embodiment, the insert 466 is fabricated of a polymer such as acetal or polymer with glass or another filler or other material exhibits similar properties and/or characteristics. By way of example and without limitation, in one exemplary embodiment, the insert 466 is fabricated a polyoxymethylene thermoplastic polymer exhibiting high stiffness, low friction, dimensional stability and excellent wear and abrasion resistance or other material exhibiting similar characteristics. One commercially available polyoxymethylene thermoplastic polymer is Delrin® polymer available from E.I. DuPont DeNemours and Company, Wilmington, Delaware. It should be understood, of course, that the insert 466, while desirable, is optional, and the first bearing race 422 could be defined by the U-shaped slot 465 of the arcuate body 462, depending on the loading forces applied to the first bearing race 422, the material(s) that the arcuate body 462 is fabricated of and/or coatings applied to the arcuate body 462 in the region of the U-shaped slot 465, the durability desired and the coefficient of sliding friction desired for the first bearing race 422, among other factors.

Similarly, in one exemplary embodiment, the upper bearing region 480 of the second saddle member 470 includes an arcuate body 482 which is generally rectangular in cross section including an inner wall 482a, an axially spaced apart outer wall 482b, an upper surface 482c and a radially spaced apart lower surface 482d. The upper surface 480c of the arcuate body 482 includes a J-shaped opening 483, as viewed in cross section. An interior region 484 of the J-shaped opening 483 defines a U-shaped slot 485. A low friction, durable U-shaped insert 486 is fixedly positioned in the U-shaped slot 485. The low friction insert 486 includes a U-shaped slot 487, as viewed in cross section. The U-shaped slot 487 of the insert 486 defines the U-shaped surface 443 and the inner and outer bearing races 444, 445 of the first second race 442 which slidingly receives the second arcuate rim bearing 342 of the second peripheral portion 340 of the rotatable bearing assembly 300. Stated another way, the U-shaped slot 487 of the insert 486 defines a second journal bearing race 488 comprising the second bearing race 442 of the upper bearing portion 410 of the saddle assembly 400 and the U-shaped slot 487 of the insert 486 defines second arcuate slot 440 of the upper bearing portion 410 of the saddle assembly 400. As explained above with respect to the insert 466, it should be understood that the insert 486, while desirable, is optional, and the second bearing race 442 could be defined by the U-shaped slot 485 of the arcuate body 482, depending on the loading forces applied to the second bearing race 442, the material(s) that the arcuate body 483 is fabricated of and/or coatings applied to the arcuate body 483 in the region of the U-shaped slot 485, the durability desired and the coefficient of sliding friction desired for the second bearing race 442, among other factors.

### Connecting Assembly 500

As best seen in FIGS. 3-5, 7-9 and 11-13, the connecting assembly 500 functions to couple the saddle assembly 400 of the solar tracker bearing apparatus 200 to the upper mounting portion 172 of the upright support post 170. The connecting assembly 500 includes the W brace 510, a post cap 540 which is affixed to the upper mounting portion 172 of the support post 150, and a stiffener member 560, which is interposed between the post cap 540 and an upper end 178 of the support post 150 and provides additional structural rigidity to the connecting assembly 500.

Advantageously, as mentioned previously, the connecting assembly 500, along with the lower coupling portion 402 of the saddle assembly 400, allows for adjustability in the mounting of the solar tracker bearing apparatus 200 to the upper mounting portion 172 of the support post 150 to account for the fact that given the terrain that the support posts 170 are installed, there are often various types of misalignment problems that must be accounted for in attempting to properly and precisely align, orient and position the beam slot 306 of the rotatable bearing assembly 300 of a given solar tracker bearing apparatus 200 to receive the torque tube beam 150. Misalignment problems between the support post 170 and the torque tube beam 150 can take various forms including: a) Post twist-the side walls 170 of the support post 170 which include the pair of vertically extending slots 176 are not in alignment with the longitudinal axis LA of the torque tube beam 150. Thus, if the solar tracker bearing apparatus 200 were mounted to the support post side walls 170 with post twist adjustability, the axis of rotation R of the rotatable bearing assembly 300 of the solar tracker bearing apparatus 200 would not be parallel with the torque tube beam longitudinal axis LA. Such post twist condition would cause additional undesirable forces applied to both the rotatable bearing assembly 300, the saddle assembly 400 and the torque tube beam 150. b) Y direction misalignment—the vertical center line PCVA of the post 150 is orthogonal to but offset from the torque tube beam longitudinal axis LA. Such a Y direction misalignment condition would cause difficulty in positioning the torque tube beam 150 in the beam slot 306 and/or mounting the connecting assembly 500 to the post mounting portion 172. c) Post tilt—the vertical center line CLP of the post intersects the torque tube beam longitudinal axis LA but is not orthogonal to the longitudinal axis. Such a post tilt condition would again cause difficulty in positioning the torque tube beam 150 in the beam slot 306 and/or mounting the connecting assembly 500 to the post mounting portion 172.

Advantageously, the connecting assembly 500, along with the lower coupling portion 402 of the saddle assembly 400, provide the necessary degrees of freedom or degrees of adjustability to account for post twist, Y direction misalignment, and post tilt conditions.

As noted previously and as best seen in FIGS. 4-5, 8-9 and 11, the W brace 510 includes the pair of vertically oriented outer or side walls 520 and the pair of vertically oriented inner walls 522. The outer and inner walls 520, 522 are spaced apart or separated, as measured axially (that is, as measured along the axis of rotation R or the direction X), by a central upper wall 524 and a pair of flanking lower walls 526. This arrangement results in a three channel configuration for the W brace 510. The channels of the W brace 510 include: a) the inverted U-shaped channel 512 that spaces the flanges 453, 473 of the lower support regions 452, 472 of the first and second saddle members 450, 470; b) an upright channel 514 which receives the lower cylindrical sleeves 455b of lower support region 452 of first saddle member 450; and c) an upright channel 516 which receives lower cylindrical sleeves 475b of lower support region 472 of second saddle member 470. The pair of horizontal fasteners 492 extend in the direction X through aligned apertures formed in the outer and inner side walls 520, 522 of the W brace 510 and the apertures extending through the respective the lower cylindrical sleeves 455b of lower support region 452 of first saddle member 450 and the lower cylindrical sleeves 475b of lower support region 472 of second saddle member 470 to secure the saddle assembly 400 to the W brace 510 of the connecting assembly 400. Advantageously, the apertures through the lower cylindrical sleeves 455b, 475b of the first and second saddle members 450, 470 constitute arched or arcuate slots 459, 479. The arcuate slots 459 provide for tilt adjustability of the solar tracker bearing apparatus 200 with respect to the center line PCVA though the support post 170 and, thus provides for adjustability to account for a post tilt condition. In one exemplary embodiment, the arcuate extent of the arcuate slots 459, 479 is sufficient to allow for +/−2° of tilt adjustability with respect to the post 150 in the direction X.

As best seen in FIGS. 5, 8-9 and 12, the post cap 540 includes a central horizontal planar section or horizontal upper wall 542 that is rectangular in shape and pair of vertically downwardly extending side walls 550, 552 extending from opposite sides 544a, 544b of the horizontal upper wall 542 of the post cap 540. The vertical side walls 550, 552 are parallel and extend in the direction X, that is, parallel to the rotatable bearing assembly axis of rotation R and parallel to the torque tube beam longitudinal axis LA. The remaining opposite two sides 544c, 544d of the horizontal upper wall 542 of the post cap 540 are open, that is, there are no side walls extending from sides 544c, 544d. The horizontal upper wall 542 and side walls 550, 552 of the post cap 540 define and inverted U-shaped opening 554. Each of the downwardly extending side walls 550 includes an array of four spaced apart apertures 556. Eight horizontally extending fasteners 559 extend in the direction Y (orthogonal to the axis of rotation R) through each of the four apertures 556 and through the aligned vertically extending slots 176 in the side walls 174 of the upper mounting portion 172 of the support post 150 to secure the connecting assembly 500 to the support post 150 and thereby mount the solar tracker bearing apparatus 200 to the support post 150. Advantageously, the fact that the mounting slots 176 of the support post 150 extend vertically allows for a range of height adjustment of the solar tracker bearing apparatus 200 with respect to an upper end 178 of the support post 170. That is, the height adjustment of the post cap 540 allows a vertical position of the rotatable bearing assembly 300 to be adjusted in the vertical direction V with respect to the upper end 178 of the support post 150 such that the torque tube beam 150 fits snugly in the beam slot 306.

As best seen in FIGS. 5, 7-9 and 13, the stiffener member 560 is attached to the post cap 540 and is interposed between the post cap 540 and the upper end 170 of the support post 150 and functions to increase structural rigidity of the connecting assembly 500. The stiffener member 560 includes a central horizontal planar section or horizontal upper wall 562 that is rectangular in shape and pair of vertically downwardly extending side walls 570, 575 extending from opposite sides 564c, 564d of the horizontal upper wall 562 of the stiffener member 560. The side walls 570, 572 of the stiffener member 560 are parallel and extend in the horizontal direction Y, that is, perpendicular to the rotatable bearing assembly axis of rotation R and perpendicular to the torque tube beam longitudinal axis LA. The remaining opposite two sides 564a, 564b of the horizontal upper wall 562 of the stiffener member 560 are open, that is, there are no side walls extending from sides 564a, 564b. The horizontal upper wall 562 and side walls 570, 572 of the stiffener member 560 define and inverted U-shaped opening 574.

Advantageously, the horizontal upper wall 562 and side walls 570, 572 of the stiffener member 560 is sized to be received within the inverted U-shaped opening 554 of the post cap 540. That is, the horizontal upper wall 542 of the post cap overlies and is in planar contact with the horizontal upper wall 562 of the stiffener member 560. Further, the side walls 570, 572 of the stiffener member 570 are orthogonal to the side walls 550, 552 of the post cap 540 such that vertical edges 573 of the respective side walls 570, 572 of the stiffener member 560 are orthogonal to and abut the respective side walls 550, 552 of the post cap 540. The side walls 550, 552, 570, 572 of the post cap 540 and stiffener member 560 form a box-like configuration of four orthogonal, vertically extending side walls 550, 552, 570, 572 which advantageously functions to increase the structural rigidity of the connecting assembly 500.

As explained above, the lower coupling portion 402 of the saddle assembly 400 is affixed to the W brace 510 and the post cap 540 is affixed to the upper mounting portion 172 of the support post 150. The U-shaped opening 574 of the stiffener member 560 is received on the upper end 178 of the support post 150. The stiffening member 560 is held rigidly and firmly in place on the upper end 178 of the support post 150 by the horizontal upper wall 542 of the post cap 540 which bears against the horizontal upper wall 562 of the stiffener member 560 and sandwiches the stiffener member 560 against the upper end 178 of the support post 170 when the post cap 540 is affixed to the side walls 174 of the support post 170 via a pair of fasteners. Thus, both the post cap 540 and the stiffening member 574 are rigidly and firmly affixed to the support post 170.

The horizontal upper walls 542, 562 of the post cap 540 and stiffener member 560 each include an aligned array of four concentric arcuate openings or slots. The horizontal upper wall 542 of the post cap 540 includes an array four arcuate slots 558. The four arcuate slots 558 are generally centered about a vertical center line UWVCL though the horizontal upper walls 542, 562 of the post cap 540 and stiffener member 560. The horizontal upper wall 542 of the stiffener member 560 includes an aligned array of four arcuate slots 578. The four arcuate slots 578 are generally centered about or concentric with the vertical center line UWVCL. The four arcuate slots 558 of the horizontal upper wall 542 of the post cap 540 and the four arcuate slots 558 of the horizontal upper wall 562 of the stiffener member 560 are vertically aligned and are concave with respect to the vertical center line UWVCL. In one exemplary embodiment, the four arcuate slots 558 are concentric with a center point on the vertical center line UWVCL. Additionally, the pair of spaced apart lower walls 526 of the W brace 510 each include a pair of straight slots 528 forming an array of four straight slots which are generally centered about a vertical center line BVCL through the W brace 510. The combination of the array of four arcuate slots 558, 578 of the horizontal upper walls 542, 562 of the post cap 540 and stiffener member 560, combined with the array of four straight slots 528 of the lower walls 526 of the W brace 510 advantageously allow for: a) limited rotational adjustability of the W brace 510 and, thus, the saddle assembly 400 and rotational bearing assembly 300, which are affixed to the W brace 510, with respect to the post cap 540 to account for the post twist condition; and b) limited linear adjustability of the W brace 510 and, thus, the saddle assembly 400 and rotational bearing assembly 300, which are affixed to the W brace 510, in the Y direction (orthogonal to the axis of rotation R) to account for Y direction misalignment condition.

Four vertically extending fasteners 580 extend through the aligned four straight slots 528 of the lower walls 526 of the W brace 510, the four arcuate slots 558 of the horizontal upper wall 542 of the post cap 540 and the four arcuate slots 578 of the horizontal upper wall 562 of the stiffener member 560 to secure the assembled combination 600 of the W brace 510, the saddle assembly 400 and rotational bearing assembly 300 to the post cap 540 and stiffener member 560 and thereby secure the assembled combination 600 to the support post 170. Advantageously, because the overlap of the four straight slots 528 of the lower walls 526 of the W brace 510, the four arcuate slots 558 of the horizontal upper wall 542 of the post cap 540 and the four arcuate slots 578 of the horizontal upper wall 562 of the stiffener member 560, the assembled combination 600 of the W brace 510, the saddle assembly 400 and rotational bearing assembly 300 to the post cap 540 may be rotated about the vertical center line BVCL through the W brace 510. This rotational adjustability of the W brace 510, the saddle assembly 400 and rotational bearing assembly 300 account for the post twist condition. In one exemplary embodiment, the angular range of rotation of the assembled combination 600 of the W brace 510, the saddle assembly 400 and the rotational bearing assembly 300 about the vertical center line BVCL is approximately +/−8 degrees.

Additionally, because of the aligned four straight slots 528 of the lower walls 526 of the W brace 510, advantageously, the assembled combination 600 of the W brace 510, the saddle assembly 400 and the rotational bearing assembly 300 have limited travel or adjustability permitted in the direction Y (orthogonal to the axis of rotation R). This linear adjustability of the assembled combination 600 of the W brace 510, saddle assembly 400 and rotational bearing assembly 300 in the direction Y accounts for the Y direction misalignment condition. In one exemplary embodiment, the linear adjustability along the direction Y resulting from the four straight slots 528 of the lower walls 526 of the W brace 510 is +/−0.75 in.

In one exemplary embodiment, the first and second bearing members 350, 370 of the rotatable bearing assembly 300 and the first and second saddle members 450, 470 of the saddle assembly 400 are fabricated of cast aluminum. The first and second bearing members 350, 370 and first and second saddle members 450, 470 could also be made of other materials having similar characteristics or properties including but not limited to cast steel, machined aluminum, machined steel and molded polymer. In one exemplary embodiment, the components of the connecting assembly 500 are made of steel, but could also be made of aluminum or a polymer or filled or reinforced polymer.

### Second Exemplary Embodiment—Solar Tracker Bearing Assembly 1200

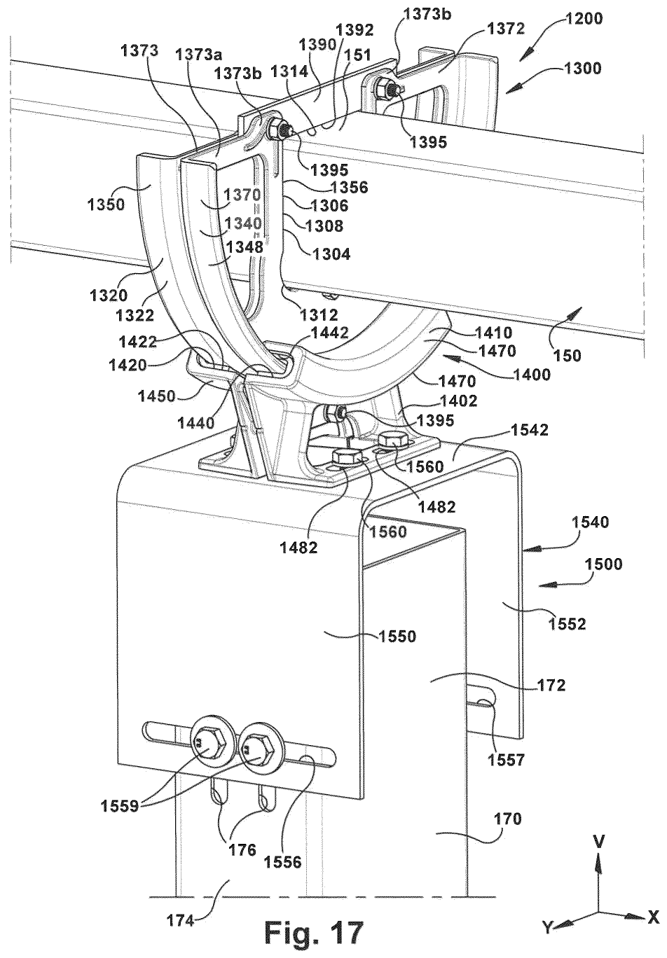

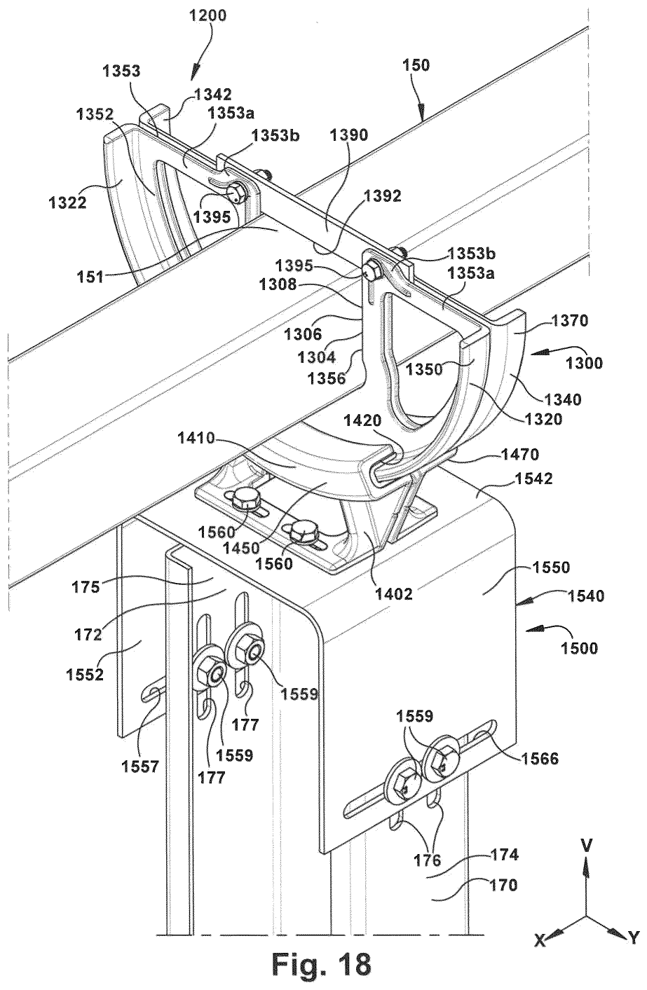

A second exemplary embodiment of a solar tracker bearing apparatus of the present disclosure is shown generally at 1200 in FIGS. 17-22B and 35. The solar tracker bearing apparatus 1200 is similar in structure and function to the solar tracker bearing apparatus 200 of the first exemplary embodiment and may be utilized in connection with the solar tracker system 100, as previously described. The description and disclosures, including drawings, relating to the solar tracker bearing apparatus 200 and the solar tracker system 100 are incorporated herein by reference as supplemental to the description of the solar tracker bearing apparatus 1200 and, for brevity, discussion of components, structure and functions common or applicable to both embodiments 200, 1200 will not be repeated.

The solar tracker bearing apparatus 1200 includes a rotatable bearing assembly 1300 supported for rotation about an axis of rotation R by a stationary saddle assembly 1400. The solar tracker bearing apparatus 1200 further includes a connecting assembly 1500 for adjustably securing the saddle assembly 1400 to the upper mounting portion 172 of the mounting post 170. In one exemplary embodiment, the connecting assembly 500 affixes a lower coupling portion 1402 of the saddle assembly 400 to the upper mounting portion 172 of the support post 170. The bearing apparatus 1200 receives and provides bearing support to a longitudinally extending support beam 150 of the solar tracker system 100, such as the torque tube support beam depicted in the drawings. Specifically, the bearing apparatus 1200 receives and rotatably supports an extending portion 151 of the support beam 150 extending through the bearing apparatus 1200. The support beam 150, such as the torque tube beam depicted in the drawings extends along a longitudinal axis LA that is substantially parallel to the bearing assembly axis of rotation R. One of skill in the art would recognize that the torque tube support beam or torque tube beam 150, depicted in the drawings, having a continuous, generally square-shaped cross-section and rounded corners, is one exemplary embodiment of a support beam capable of use with the solar tracker system 100. One of skill in the art would also recognize that the solar tracker bearing apparatuses 200, 1200 of the present disclosure may be utilized in connection with rotatably supporting a variety of support beam shapes and configurations. For example and without limitation, the solar tracker bearing apparatuses 200, 1200, may be used to rotatably support a variety of support beams, a rectangular shaped support beam, a C-shaped or J-shaped support beam, or a hat-shaped support beam (not shown), as viewed in cross section, in addition to the torque tube support beam 150 depicted in the drawings. It is the intent to include to include all such support beam configurations, within the scope of the present application. Further, the terms support beam, torque tube beam, and torque tube support beam will be used interchangeably herein.

As best seen in FIGS. 17-22B, in one exemplary embodiment, the rotatable bearing assembly 1300 includes a central portion or region 1302 and first and second spaced apart arcuate peripheral portions or regions 1320, 1340. The central portion 1302 of the bearing assembly 1300 includes a channel 1304 defining a beam slot or support beam slot or torque tube beam slot 1306 for receiving the support beam or torque tube beam 150. The beam slot 1306 includes spaced apart vertical side walls 1308 and the horizontally extending lower wall 1310. An upper wall 1314 of the beam slot 1306 is formed by a lower wall 1392 of a hold down bracket 1390. The beam slot 1306 receives and supports the square cross sectional shape of the torque tube beam 150. The first peripheral portion 1320 of the bearing assembly 300 includes a first arcuate rim bearing 1322 and the second peripheral portion 1340 includes a second arcuate rim bearing 1342. The first and second rim bearings 1322, 1342 are spaced apart as viewed in an axial direction, that is, as measured or viewed along the axis of rotation R of the rotatable bearing assembly 300 (stated another way, spaced apart as measured in the horizontal direction X) and are centered about the axis of rotation R. Further, the first and second rim bearings 1322, 1342, as viewed with respect to the axis of rotation R, have substantially the same radius. The first rim bearing 1322 is part of a first bearing member 1350 and the second rim bearing 1342 is part of a second bearing member 1370, which, in one exemplary embodiment, are identical parts. To facilitate a flush fit between the portion 151 of the torque tube beam 150 received in the beam slot 1306 and, specifically, to facilitate a flush fit between side walls 158 of the torque tube beam portion 151 and the opposing side walls 1308 of the beam slot 1306 and between the lower wall 157 of the torque tube beam portion 151 and the bottom wall 1310 of the beam slot 1306 and to facilitate ease of removal of the torque tube beam portion 151 from the beam slot 1306, there are double radius recesses 1312 forming the corner transitions between the opposing side walls 1308 and the bottom wall 1310 of the beam slot 1306.

In one exemplary embodiment, the stationary saddle assembly 400 includes the lower coupling portion 1402, adapted to be affixed to the connecting assembly 1500, and an upper bearing portion 1410, for pivoting support of the rotatable bearing assembly 1300 about the bearing assembly axis of rotation R. The upper support portion 1410 of the saddle assembly 1400 includes a first arcuate slot 1420 and a second arcuate slot 1440. The first arcuate slot 1420 includes a first arcuate bearing race 1422 and the second arcuate slot 1440 includes a second arcuate bearing race 1442. The first and second arcuate bearing races 1422, 1442 are spaced apart as viewed in an axial direction, that is, as measured or viewed along the axis of rotation R of the rotatable bearing assembly 1300 (stated another way, spaced apart as measured in the horizontal direction X) and are centered about the axis of rotation R. Further, the first and second arcuate bearing races 1422, 1442, as viewed with respect to the axis of rotation R, have the same radius or radius of curvature as the first and second rim bearings 1322, 1342. The first bearing race 1422 is part of a first saddle member 1450 and the second bearing race 1442 is part of a second bearing member 1470, which, in one exemplary embodiment, are identical parts. The first arcuate bearing race 1422 slidably supports the first arcuate rim bearing 1322 of the rotatable bearing assembly 1300 and the second arcuate bearing race 1442 slidably supports the second arcuate rim bearing 1342 of the rotatable bearing assembly 1300 such that the arcuate or pivoting movement of the rotatable bearing assembly 1300 is centered about the axis of rotation R.

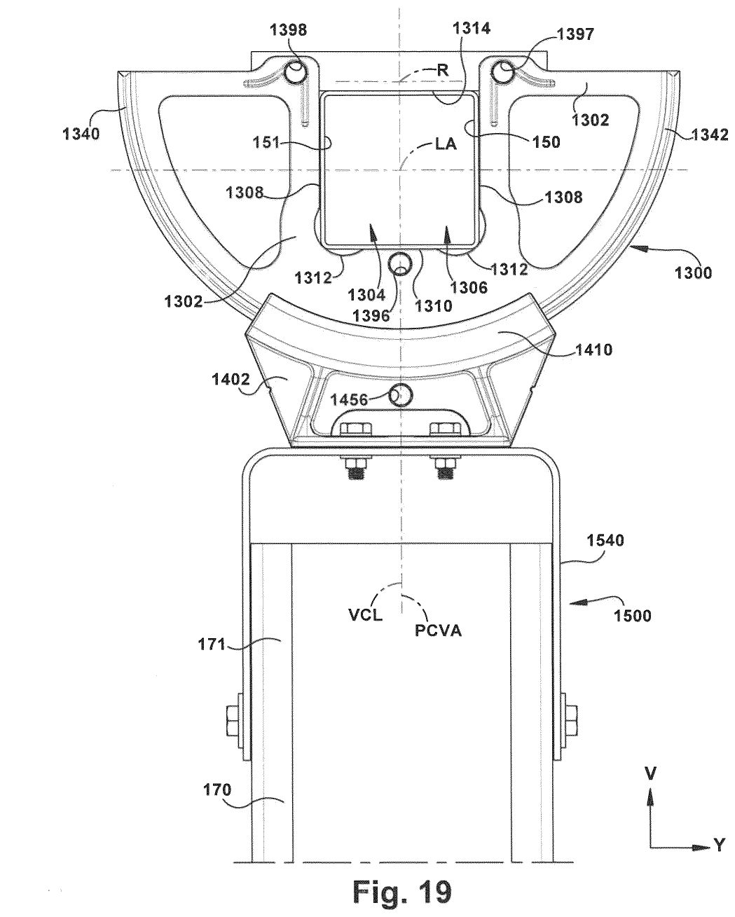

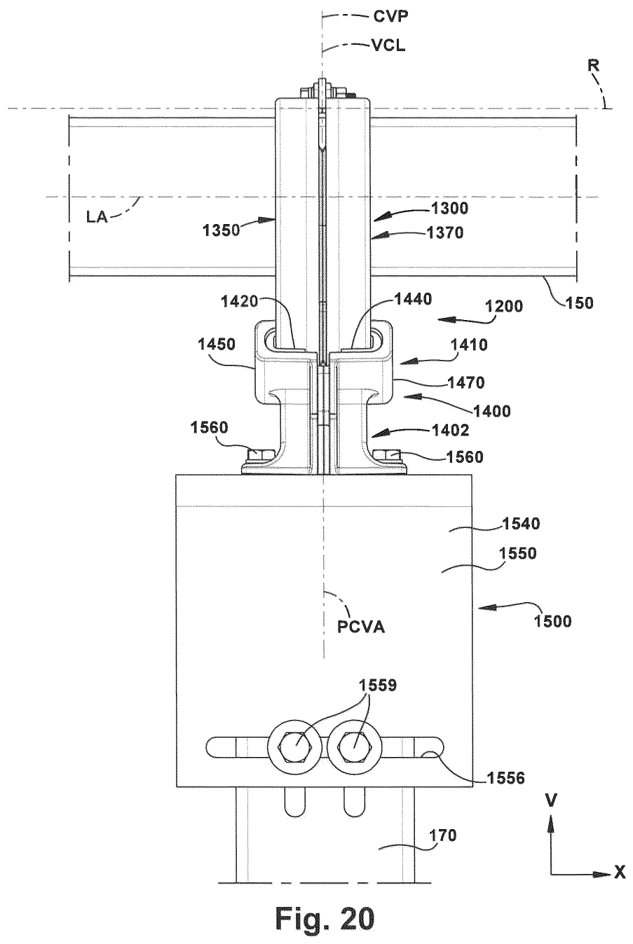

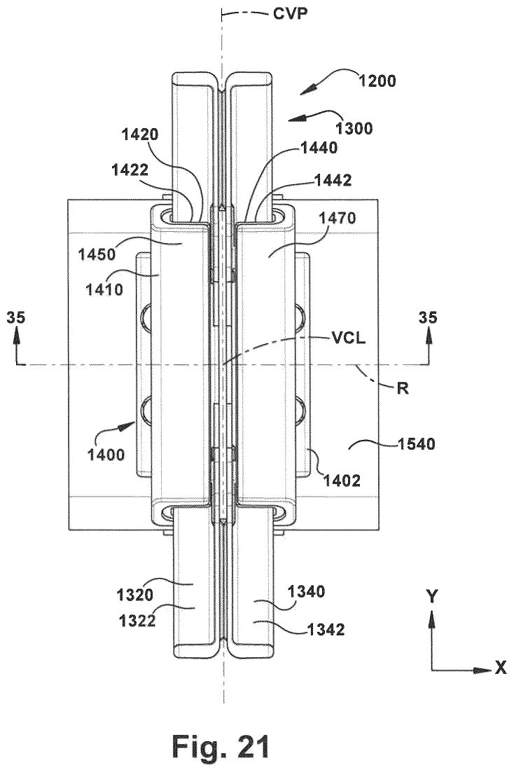

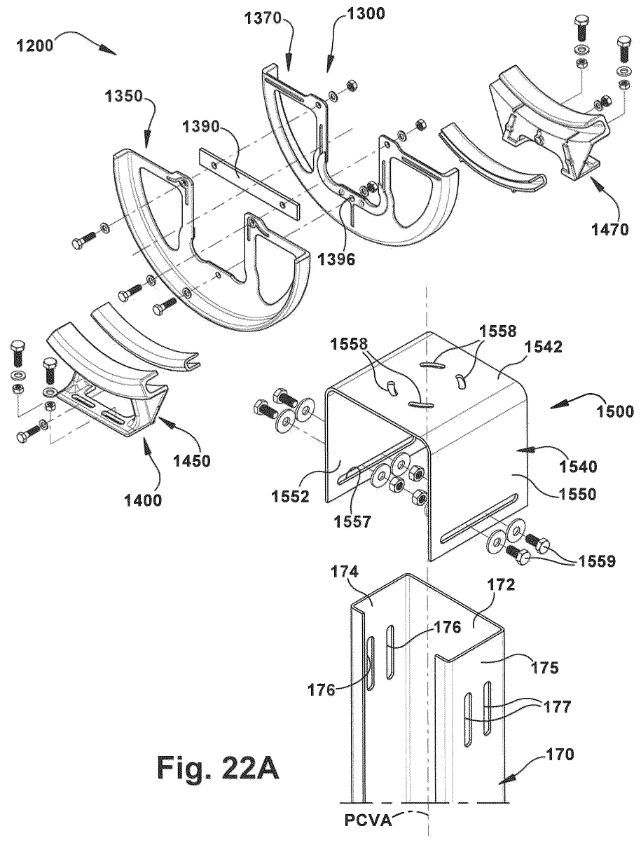

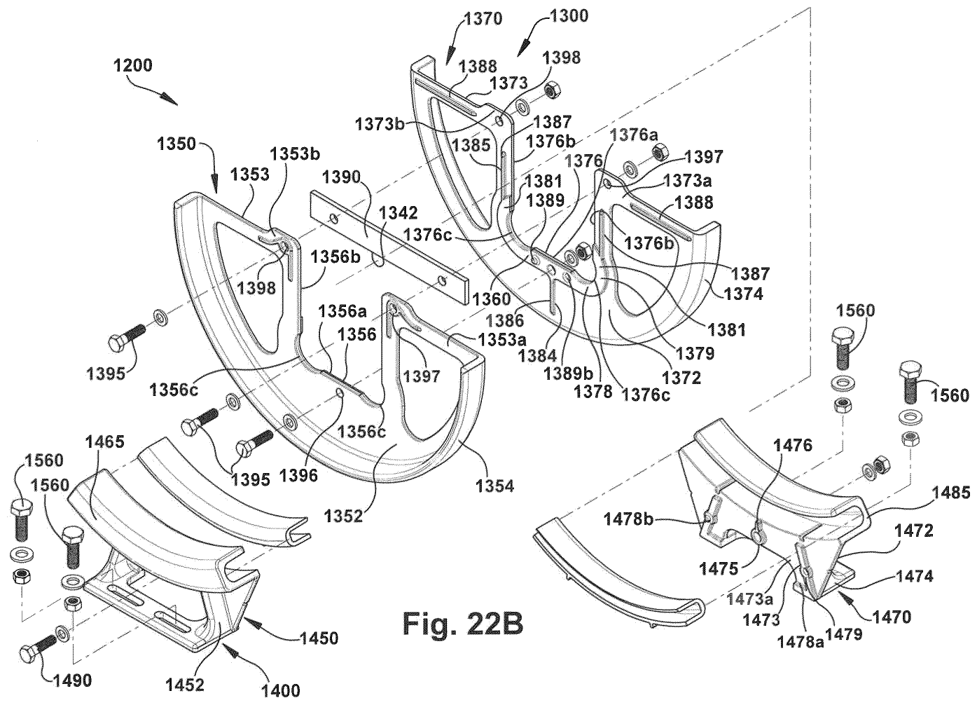

As best seen in FIGS. 22A and 22B, in one exemplary embodiment, the rotatable bearing assembly 1300 and the stationary saddle assembly 1400 of the solar tracker bearing apparatus 1200 are both two-part assemblies that are symmetric about a central vertical plane CVP (FIGS. 20 and 21) extending through the solar tracker bearing apparatus 1200. The central vertical plane CVP of the solar tracker bearing apparatus 1200 extends orthogonally to and is intersected by the axis of rotation R of the rotatable bearing assembly 1300, that is, the central vertical plane CVP of the solar tracker bearing apparatus 1200 extends in the vertical direction V. The central vertical plane CVP of the solar tracker bearing apparatus 1200 includes a vertical center line VCL (FIGS. 19 and 21) of the apparatus 1200 that intersects and is orthogonal to the axis of rotation R of the rotatable bearing assembly 1300. In one exemplary embodiment, the rotatable bearing assembly 1300 includes first and second bearing members 1350, 1370 and the saddle assembly 1400 includes first and second saddle members 1450, 1470. Because the first and second bearing members 1350, 1370 are symmetrical about the central vertical plane CVP, advantageously, as explained above, the members 1350, 1370 are identical, leading to significant efficiencies in the manufacture of the rotatable bearing assembly 1300 and reducing inventory requirements. Similarly, because the first and second saddle members 1450, 1470 are symmetrical about the central vertical plane CVP, advantageously, as explained above, the members 1450, 1470 are identical, leading to significant efficiencies in the manufacture of the saddle assembly 1300 and reducing inventory requirements.

### Rotatable Bearing Assembly 1300

As best seen in FIGS. 17-27 and 35, in one exemplary embodiment, the rotatable bearing assembly 1300 of the solar tracker bearing apparatus 1200 is a two-part assembly that is symmetric about the central vertical plane CVP (FIGS. 20 and 21) extending through the solar tracker bearing apparatus 1200. The central vertical plane CVP of the solar tracker bearing apparatus 200 is parallel to and aligned with a central vertical axis PCVA (FIGS. 19, 20 and 22A) of the support post 170 and extends orthogonally to and is intersected by the axis of rotation R of the rotatable bearing assembly 1300, that is, the central vertical plane CVP of the solar tracker bearing apparatus 1200 extends in the vertical direction V (FIGS. 17-20). The central vertical plane CVP of the solar tracker bearing apparatus 200 includes the vertical center line VCL (FIGS. 19-21) of the bearing apparatus 1200 that intersects and is orthogonal to the axis of rotation R of the rotatable bearing assembly 1300.

The first bearing member 1350 of the rotatable bearing assembly 1300 is generally semicircular including a generally planar central portion or region 1352 and a laterally extending peripheral rim 1354. The planar central portion 1352 is substantially parallel to but spaced laterally from the central vertical plane CVP of the solar tracker bearing apparatus 1200. The planar central region 1352 includes a generally u-shaped cut-out 1356 extending vertically downwardly from an upper edge 1353 of the central region 1352. The u-shaped cut-out 1356 includes a horizontally extending lower surface 1356a and a pair of opposing vertically extending side surfaces 1356b. A pair of arcuate or radius recessed surfaces 1356c bridge the lower surface 1356a and side surfaces 1356b. Extending laterally from the planar central region 1352 adjacent the u-shaped cut-out 1356 is a first projection 1358. Also extending laterally from the planar central region are a first set of protuberances 1364. The first projection 1358 and the first set of protuberances 1364 extend axially toward the second bearing member 1370.

Similarly, the second bearing member 1370 is generally semicircular including a generally planar central region or portion 1372 and a laterally extending peripheral rim 1374. The planar central region or portion 1372 is substantially parallel to but spaced laterally from the central vertical plane CVP of the solar tracker bearing apparatus 1200. The central region 1372 includes a generally u-shaped cut-out 1376 extending vertically downwardly from an upper edge 1373 of the central region or portion 1372. The u-shaped cut-out 1376 includes a horizontally extending lower surface 1376a and a pair of opposing vertically extending side surfaces 13f6b. A pair of arcuate or radius recessed surfaces 1356c bridge the lower surface 1356a and side surfaces 1356b. Extending laterally from the planar central region 1372 adjacent the u-shaped cut-out 1376 is a second projection 1378. Also extending laterally from the planar central region are a second set of protuberances 1384. The second projection 1378 and the second set of protuberances 1364 extend axially toward the first bearing member 1370. In one exemplary embodiment, the first and second bearing members 1350, 1370 and, specifically, the planar central regions 1352, 1372 are spaced apart axially (that is, as measured along the rotatable bearing member axis of rotation R) by the aligned contact of the first and second projections 1358, 1378 and the aligned contact of the first and second set of protuberances 1364, 1384. Facing surfaces 1359, 1379 of the first and second projections 1358, 1378 and facing surfaces 1365, 1385 of the first and second set of protuberances 1364, 1384 engage along the central vertical plane CVP of the bearing apparatus 1200.

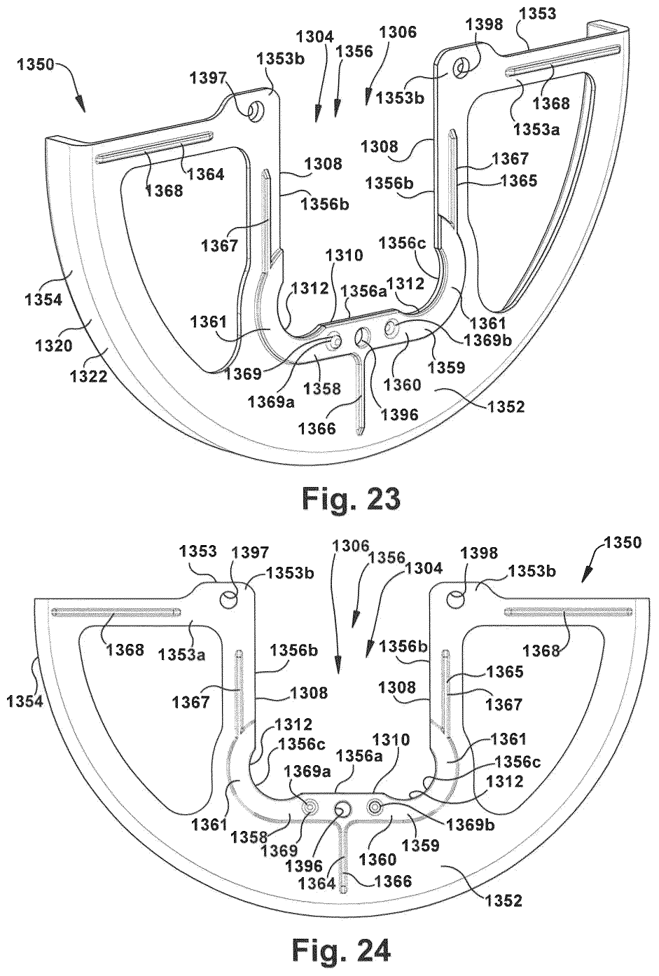

As best seen in FIGS. 23-24 and 35, in one exemplary embodiment, the first projection 1358 of the first bearing member 1350 extends axially (that is, extends in the X direction parallel to axis of rotation R) from the planar central region 1352 adjacent the u-shaped cut-out 1356. As viewed from a plane orthogonal to the bearing assembly axis of rotation R, for example, as viewed from the central vertical plane CVP of the bearing apparatus 1200, the first projection 1358 is generally u-shaped, conforming to the shape of a lower region of the u-shaped cut-out 1356. Specifically, in one exemplary embodiment, the first projection 1358 includes a base 1360 extending along at least a portion of the lower surface 1356a of the cut-out 1356 and first and second vertically extending, arcuate arms 1361 extending from the base 1360 and extending along at least a portion of the two radius surfaces 1356c and the first and second side surfaces 1356b of the cut-out 1356. The first set of protuberances 1364 also extend axially from the planar central region 1352 toward the second bearing member 1370. The first set of protuberances 1364, in one exemplary embodiment, include: a) a central vertical protuberance 1366 extending downwardly from the base 1360 of the projection 1358; b) a pair of vertical protuberances 1367 extending upwardly from upper regions of the first and second arcuate arms 1361 of the first projection 1358; and c) a pair of horizontally extending protuberances 1368 positioned near the upper edge 1353 of the planar central region 1352 of the first bearing member 1350.

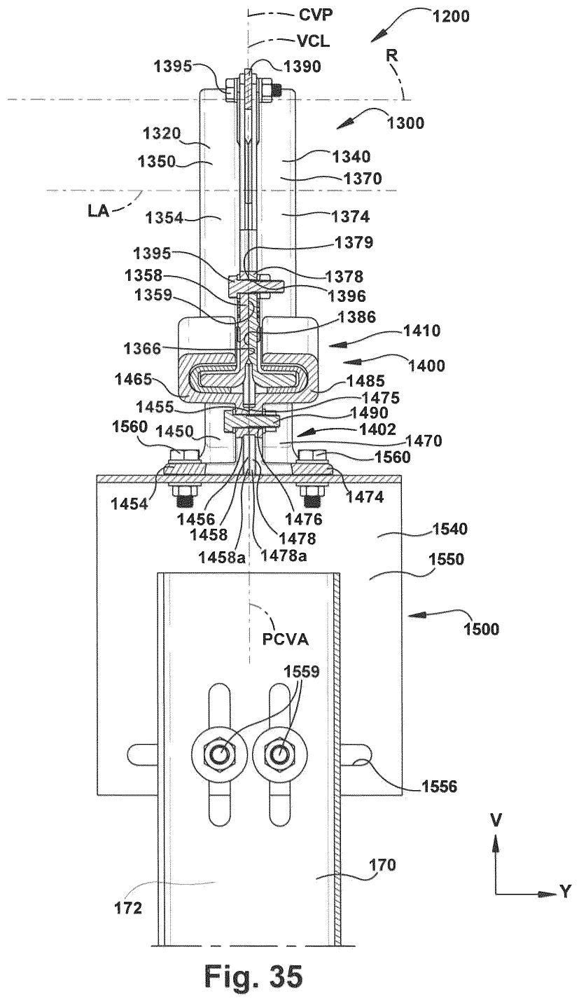

Similarly, as best seen in FIGS. 22A, 22B and 35, in one exemplary embodiment, the second projection 1378 of the second bearing member 1370 extends axially (that is, extends in the X direction parallel to axis of rotation R) from the planar central region 1372 adjacent the u-shaped cut-out 1376. As viewed from a plane orthogonal to the bearing assembly axis of rotation R, for example, as viewed from the central vertical plane CVP of the bearing apparatus 1200, the second projection 1378 is generally u-shaped, conforming to the shape of a lower region of the u-shaped cut-out 1376. Specifically, in one exemplary embodiment, the second projection 1378 includes a base 1380 extending along at least a portion of the lower surface 1376a of the cut-out 1376 and first and second vertically extending, arcuate arms 1381 extending from the base 1380 and extending along at least a portion of the two radius surfaces 1376c and the first and second side surfaces 1376b of the cut-out 1376. The second set of protuberances 1384 also extend axially from the planar central region 1352 toward the first bearing member 1350. The second set of protuberances 1384, in one exemplary embodiment, include: a) a central vertical protuberance 1386 extending downwardly from the base 1380 of the projection 1378; b) a pair of vertical protuberances 1387 extending upwardly from upper regions of the first and second arcuate arms 1381 of the second projection 1378; and c) a pair of horizontally extending protuberances 1368 positioned near the upper edge 1373 of the planar central region 1372 of the second bearing member 1370.

Advantageously, the engagement and contact of first and second projections 1358, 1378 and the first and second sets of protuberances 1364, 1384 function to axially space the respective planar central regions 1352, 1372 of the first and second bearing members 1350, 1370. As discussed above, with respect to the first embodiment, increasing the axial spacing of the axial distance between bearing engagement surfaces of the rim bearings 1322, 1342 of the bearing assembly 1300 and the bearing engagement surfaces of the first and second bearing races 1422, 1442 of the saddle assembly 400 advantageously provides for improved bearing support and improved stability for the bearing assembly 1300 as it rotates with respect to the saddle assembly 1400 about the axis of rotation R. Additionally, the surfaces of first projection 1358 adjacent the bottom surface 1356a and side surfaces 1356b of the u-shaped cut-out 1356 of the first bearing member 1350 effectively extends and enlarges the bottom and side surfaces 1356a, 1356b of the cut-out 1356. Similarly, the surfaces of second projection 1378 adjacent the bottom surface 1376a and side surfaces 1376b of the u-shaped cut-out 1376 of the second bearing member 1370 effectively extends and enlarges the bottom and side surfaces 1376a, 1357b of the cut-out 1376. Since the aligned cut-outs 1356, 1376 of the first and second members 1350, 1370 define, in part, the torque tube beam slot 1306. This enhanced surface area of the beam slot 1306 afforded by the extension of the bottom and side surface 1376a, 1376b of the cut-out 1376 advantageously provides for increased area of support and thus increased stability in support of the torque tube beam 150 as it is received in the beam slot 1306 and is pivotally supported by the bearing assembly 1300.

As best seen in FIGS. 17-19, 22A and 22B, the hold down bracket 1390 is disposed between respective upper portions 1353a, 1573a of the central regions 1352, 1372 of the first and second bearing members 1350, 1370. The hold down bracket 390 functions to both secure the portion 151 of the torque tube beam 150 disposed within the beam slot 1306 and laterally space apart the central regions or portions 1352, 1372 of the first and second bearing members 1350, 1370. Accordingly, the torque tube beam 150 is confined from movement within the beam slot 1306 by the beam slot bottom wall 1310, the pair of beam slot side walls 1308 and the upper wall 1314 defined by the lower or bottom wall or end 1392 of the hold down bracket 390. The beam slot bottom wall 1310 is defined by the lower surface 1356a of the u-shaped cut-out 1356 of the first bearing member 1350 and portions the base 1360 of the first projection 1356 adjacent and extending the lower surface 1356a of the cut-out 1356. The beam slot bottom wall 1310 is also defined by the lower surface 1376a of the u-shaped cut-out 1376 of the second bearing member 1370 and portions the base 1380 of the second projection 1378 adjacent to and extending the lower surface 1376a of the cut-out 1376. The beam slot vertical side walls 1308 are defined by the side surfaces 1356b of the cut-out 1356 of the first bearing member 1350 and portions of the arcuate arms 1361 of the first projection 1356 adjacent to and extending the side surfaces 1356b of the cut-out 1356. The beam slot vertical side walls 1308 are also defined by the side surfaces 1376b of the cut-out 1376 of the second bearing member 1370 and portions of the arcuate arms 1381 of the second projection 1378 adjacent to and extending the side surfaces 1376b of the cut-out 1376.

In one exemplary embodiment, an axial extent of the first projection 1358 and the second projection 1378 extend from the respective central regions 1352, 1372 of the first and second bearing members 1350, 1370, as measured in the direction X parallel to the bearing assembly axis of rotation R, are each approximately 0.09 in., thereby spacing the facing surfaces of the central portion 1352, 1372 of the first and second bearing members 1350, 1370 by approximately 0.18 in. While the first and second projections 1358, 1378 of the first and second bearing members 1350, 1370 are smaller in axial extent that the pairs of projections 358, 378 of the first and second bearing members 350, 370, the advantages of: a) increased stability due to an increased area of support provided by the beam slot 1306 to the torque tube beam 150; and b) increase stability due to an increase in the axial spacing between the peripheral bearing rim 1354 (defining the first arcuate rim bearing 1322) of the first bearing member 1350 and the peripheral bearing rim 1374 (defined the second arcuate rim bearing 1342) of the second bearing member 1370 still exist to a certain degree. By contrast, the smaller axial extent of the first and second projections 1358, 1378 provide for reduced material requirement and, thus, lower manufacturing cost for the first and second bearing members 1350, 1370, as compared with the first and second bearing members 350, 370 of the bearing apparatus 200 of the first exemplary embodiment. Thus, as one of skill in the art would recognize, the extent of axial spacing between the first and second bearing members 1350, 1370 provided by the first and second projections 1358, 1378 may be varied depending on design objectives and cost considerations. Additionally, the addition of the first and second set of protuberances 1364, 1384 increase and spread out the areas of contact between the first and second members 1350, 1370 thereby increasing overall stability of the central regions 1352, 1372 of the first and second members 1350, 1370, as compared with the smaller and more concentrated area of contact between the contacting surfaces of the pairs of projections 358, 378 of the first and second bearing members 350, 370 of the first bearing apparatus 200.

The first projection 1358 of the first bearing member 1350 advantageously further includes an interfitting alignment structure 1369 (FIGS. 23 and 24) that engages a mating alignment structure 1389 (FIGS. 22A and 22B) of the second projection 1378 of the second bearing member 1370. The interfitting alignment structures 1369, 1389 facilitate alignment of the first and second bearing members 1350, 1370 and provides additional strength and stability to the coupling of the first and second bearing members 1350, 1370 and thereby enhances the support of the torque tube beam 150 by the torque tube beam slot 1306. This is in addition to the stability of the beam slot 1306 provided by greater surface area of the beam slot 1306 (by virtue of the first and second projections 1358, 1378, as explained above) and the enhanced stability of the bearing members 1350, 1370 due to the axial spacing apart of the first and second bearing members 1350, 1370 (by virtue of the first and second projections 1358, 1378 and the first and second set of protuberances 1365, 1385), as discussed above. In one exemplary embodiment, the alignment structure 1369 of the first projection 1358 includes a first tab 1369a extending axially from the base 1360 on one side of the vertical center line VCL of the bearing apparatus 1200 and a first recess 1369b extending into the base 1360 on the opposite side and equidistant from the vertical center line VCL of the bearing apparatus 1200. The interfitting alignment structure of the 1389 of the second projection 1378 also includes a second tab 1389a extending axially from the base 1380 on one side of the vertical center line VCL of the bearing apparatus 1200 and a second recess1389b extending into the base 1380 on the opposite side and equidistant from the vertical center line VCL of the bearing apparatus 1200. Upon assembly of the first and second bearing members 1350, 1370, the first tab 1369a of the first projection 1358 of the first bearing member 1350 is snugly received in the second recess 1389b of the second projection 1378 of the second bearing member 1370 and the second tab 1389a of the second projection 1378 is snugly received in the first recess 1369b of the first projection 1358 to facilitate proper alignment of the first and second bearing members 1350, 1370 and further enhance stability of the bearing assembly 1300.

As can best be seen in the exploded view of FIGS. 22A and 22B, the first and second bearing members 1350, 1370, in one exemplary embodiment, are secured together by three fasteners 1395 that pass through aligned openings 1396, 1397, 1398 of the central regions or portions 1352, 1372 of the first and second bearing members 1350, 1370. In one exemplary embodiment, the three fasteners are conventional bolt and nut fasteners. The first opening 1396 is centered just below the lower wall 1310 of the torque tube beam slot 1306 and passes though the bases 1360, 1380 of the first and second projections 1358, 1378. The second and third openings 1397, 1398 are on opposite sides of the torque tube beam slot 1306 and pass through enlarged, dog-eared upper sections 1353b, 1373b of the upper portions 1353a, 1373b of the central regions 1353, 1373 of the of the first and second bearing members 1350, 1370. The hold down bracket 1390 also includes openings aligned with second and third openings 1397, 1398 to allow for passage of the fasteners 1395.

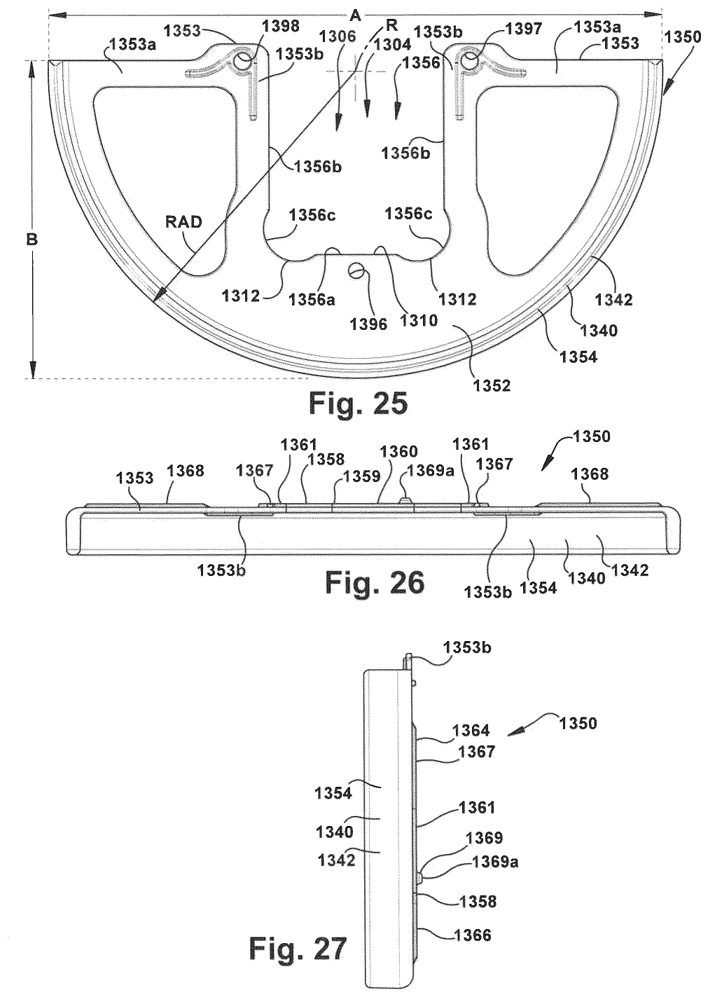

In one exemplary embodiment, with reference to FIG. 25, typical dimensions for the first and second bearing members 1350, 1370 are as follows: a width A of approximately 14.2 in., a height B of 7.37 in., and a radius RAD with respect the bearing assembly axis of rotation R of 7.11 in. As shown in FIGS. 19 and 20, in one exemplary embodiment, the bearing assembly axis of rotation is centered with respect to the width A of the first and second bearing members 1350, 1370 and is approximately 0.24 inches above the upper surface of the torque tube 151 within the torque tube beam slot 1306.

### Saddle Assembly 1400

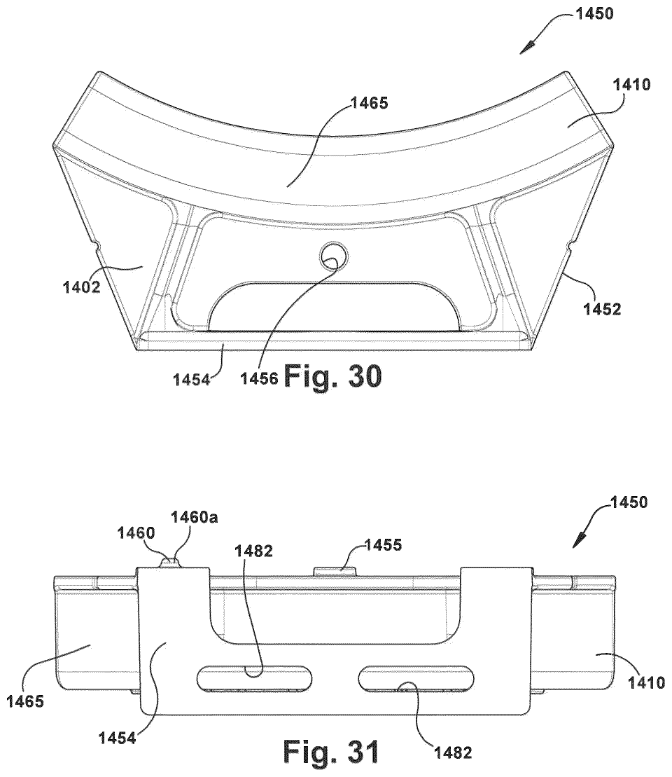

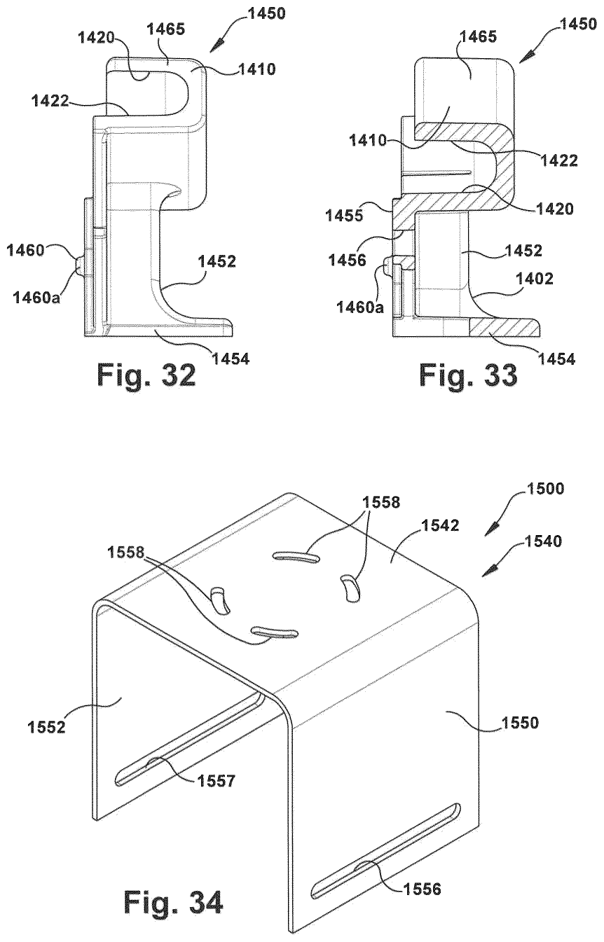

As best seen in FIGS. 17-20 and 30-33, the saddle assembly 1400 includes the lower coupling portion 1402 and the upper bearing portion 1410. As noted above, the upper bearing portion 1410 includes the first arcuate slot 1420 and the second arcuate slot 1440. The first arcuate slot 1420 includes the first arcuate bearing race 1422 and the second arcuate slot 1440 includes the second arcuate bearing race 1442. The first and second arcuate bearing races 1422, 1442 are spaced apart as viewed in an axial direction, that is, as measured or viewed along the axis of rotation R of the rotatable bearing assembly 1300 (stated another way, spaced apart as measured in the horizontal direction X) and are centered about the axis of rotation R. The first arcuate bearing race 1422 slidably supports the first arcuate rim bearing 1322 of the rotatable bearing assembly 1300 and the second arcuate bearing race 1442 slidably supports the second arcuate rim bearing 1342 of the rotatable bearing assembly 1300 such that the arcuate or pivoting movement of the rotatable bearing assembly 1300 is centered about the axis of rotation R. The upper bearing portion 1410 is similar in function and structure to the upper bearing portion 410 of the saddle assembly 400 of the first embodiment.

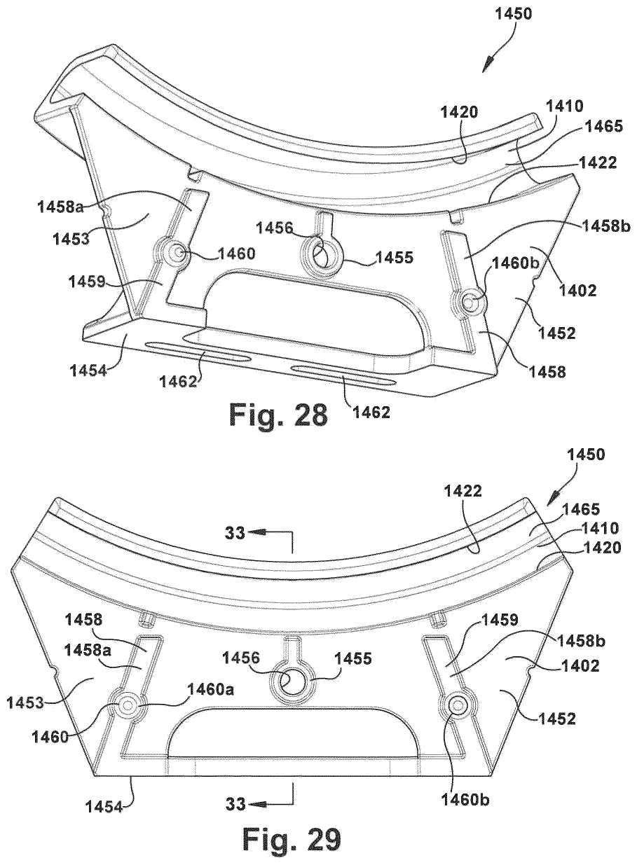

The saddle assembly 1400, in one exemplary embodiment, like the bearing assembly 1300, is a two piece assembly comprising the first saddle member 1450 and the second saddle member 1470 which are identical and symmetric about the central vertical plane CVP of the solar tracker bearing apparatus 1200. As best seen in FIGS. 28-33, the first saddle member 1450 includes an upper bearing region 1465 and a lower support region 1452 that is coupled to and supports the upper bearing region 1465. The lower support region 1452 of the first saddle member 1450 includes a downwardly or vertically extending plate 1453 and an orthogonally extending flange 1454 extending from a lower end region of the plate 1453. The plate 1453 includes a generally planar first surface 1453a facing in the direction toward an aligned lower support region 1472 of the second saddle member 1470. The plate 1453 includes a boss 1455 defining an opening 1456 extending through the plate 1453. The second saddle member 1470 similarly includes an upper bearing region 1485 and a lower support region 1472 that is coupled to and supports the upper bearing region 1475. The respective upper bearing regions 1465, 1485 of the first and second saddle members comprise the upper bearing portion 1410 of the saddle assembly 1400. The respective lower support regions 1452, 1472 comprise the lower coupling portion 1402 of the saddle assembly 1400. The lower support region 1472 of the second saddle member 1470 includes a downwardly or vertically extending plate 1473 and an orthogonally extending flange 1474 extending from a lower end region of the plate 1473. The plate 1473 includes a generally planar second surface 1473a facing in the direction toward the aligned plate 1453 of the lower support region 1452 of the first saddle member 1450. The plate 1473 includes a boss 1475 defining an opening 1476 extending through the plate 1473. A fastener 1492, such as a conventional bolt and nut fastener, pass through the aligned openings 1456, 1476 to secure the first and second saddle members 1450, 1470 together.

As best seen in FIGS. 28 and 29, the planar first surface 1453a of the plate 1453 of the first saddle member 1450 further includes a first projection 1458 that extends axially from the planar first surface 1453a in the horizontal direction X toward the planar second surface 1473a of the second saddle member 1470. That is, the first projections 1458 extends axially from the first surface 1453a in a direction toward the central vertical plane CVP of the bearing apparatus 1200. In one exemplary embodiment, the first projection 1458 comprises a pair of spaced apart projections 1458a, 1458b that are mirror images (that is, each projection of the pair of projections 1458a, 1458b is symmetric with respect to a vertical plane passing through the bearing assembly axis of rotation R) and, each of the pair of projections 1458a, 1458b are angled forming an inverted number 7 with a horizontal base and an upwardly angled leg extending from the base. The planar second surface 1473a of the plate 1473 of the second saddle member 1470 similarly includes a second projection 1478 that extends axially from the planar second surface 1473a in the horizontal direction X toward the planar first surface 1453a. That is, the second projection 1478 extends axially from the second surface 1473a in a direction toward the central vertical plane CVP of the bearing apparatus 1200. In one exemplary embodiment, the second projection 1478 comprises a pair of spaced apart projections 1478a, 1478b that, like the first pair of projections 1458a, 1458b, are mirror images or symmetric and each of the pair of spaced apart projections 1478a, 1478b is angled forming an inverted number 7 with a horizontal base and an upwardly angled leg extending from the base. Facing surfaces 1459, 1479 of the first and second projections 1458, 1479 of the first and second saddle members 1450, 1470 engage and contact to axially space apart the first and second surfaces 1453a, 1473a and thereby axially space apart the lower support regions 1452, 1472 of the first and second saddle members 1450, 1470. Each of the first and second surfaces 1453a, 1473a are spaced equidistant from the central vertical plane CVP of the solar tracking bearing apparatus 1200. Advantageously, in one exemplary embodiment, an axial extent of the first projection 1458 and the second projection 1478 extend from the respective plate surfaces 1453a, 1473a of the first and second saddle member 1450, 1470, as measured in the direction X parallel to the bearing assembly axis of rotation R, are each approximately 0.09 in., thereby spacing the respective plate surfaces 1453a, 1473a of the first and second saddle members 1350, 1370 by approximately 0.18 in., which matches the axial spacing of the first and second bearing members 1350, 1370. Axially spacing the plate surfaces 1453a, 1473a of the first and second saddle members also advantageously increases the axial distance between the first and second arcuate bearing races 1422, 1442 of the upper bearing portion 1410 of the saddle assembly 1400.

Additionally, the first projection 1458 of the first saddle member 1450 advantageously further includes an interfitting alignment structure 1460 that engages a mating alignment structure 1480 of the second projection 1478 of the second saddle member 1470 to facilitate alignment of the first and second saddle members 1450, 1470. In one exemplary embodiment, the alignment structure 1460 of the first projection 1458 includes a first tab 1460a extending axially from one projection 1458a of the pair of projections 1458a,1458b of the first projection 1458 on one side of the vertical center line VCL of the bearing apparatus 1200 and a first recess 1460b extending into the other projection 1458b of the pair of projections 1458a, 1458b of the first projection 1458 on the opposite side and equidistant from the vertical center line VCL of the bearing apparatus 1200. The interfitting alignment structure of the 1480 of the second projection 1478 also includes a second tab 1480a extending axially from one projection 1478a of the pair of projections 1478a, 1478b of the second projection 1478 on one side of the vertical center line VCL of the bearing apparatus 1200 and a second recess 1480b extending into the other projection 1478b of the pair of projections 1478a, 1478b of the second projection 1478 on the opposite side and equidistant from the vertical center line VCL of the bearing apparatus 1200.

Upon assembly of the first and second saddle members 1450, 1470, the first tab 1460a of the first projection 1458 of the first saddle member 1450 is snugly received in the second recess 1480b of the second projection 1478 of the second saddle member 1470 and the second tab 1480a of the second projection 1478 is snugly received in the first recess 1460b of the first projection 1458 to facilitate proper alignment of the first and second saddle members 1450, 1470 and further enhance stability of the bearing assembly 1300. The horizontal flange 1454 of the first bearing member 1450 includes a pair of slotted 1462 and the horizontal flange 1470 of the second bearing member 1470 includes a pair of slotted openings 1482 for affixing the first and second saddle members 1450, 1450 and thereby the saddle assembly 1400 and the bearing assembly 1300 to the post cap 1540 of the connecting assembly 1500 via four fasteners 1489. In one exemplary embodiment, the four fasteners 1489 are, such as a conventional bolt and nut fasteners.

### Connecting Assembly 1500

As best seen in FIGS. 17-22A and 34, the connecting assembly 1500 functions to couple the lower coupling portion 1402 of the saddle assembly 1400 of the solar tracker bearing apparatus 1200 to the upper mounting portion 172 of the upright support post 170. Since the upper bearing portion 1410 of the saddle assembly 1400 rotatably supports the bearing assembly 1300, securing the lower coupling portion 1402 of the saddle assembly 1400 effectively couples both the saddle assembly 1400 and the bearing assembly 1300 to the support post 170.

In one exemplary embodiment, the connecting assembly 1500 includes a post cap 1540 which is affixed to the upper mounting portion 172 of the support post 150. The post cap 1540 is generally U-shaped and includes a horizontal top wall 1542 and a pair of vertically extending, opposing side walls 1550, 1552. As best seen in FIGS. 22A and 34, the horizontal upper wall 1542 of the post cap 540 includes an aligned array of four concentric arcuate openings or slots 1558. The array of four arcuate slots 558 are generally centered about a vertical center line though the horizontal upper wall 1542 of the post cap 540. Each of the side walls 1550, 1552 includes a horizontal slot or opening 1556. The upper mounting portion 172 of the support post 150 includes a pair of opposing side walls 174, 175 each of the side walls 174 having a pair of vertically oriented slots or openings 176, 177.

Four fasteners 1560 of the connecting assembly 1500 extend vertically through slotted openings 1462, 1482 in flanges 1454, 1474 in the of the lower support regions 1452, 1472 of the first and second saddle members 1450, 1470 and extend through the array of four concentric arcuate slots 1558 of the horizontal upper wall 1542 of the post cap 540 to secure the saddle assembly 1400 to the post cap 1540. Four fasteners 1559 of the connecting assembly 1500 secure the post cap 1540 to the upper mounting portion 172 of the support post 150. Specifically, in one exemplary embodiment, two of the four fasteners 1559 extend horizontally through the horizontal slot 1556 of the side wall 1550 of the post cap 1540 and extend through respective vertical slots 176 in the side wall 174 of the upper mounting portion 172 of the support post 150. Two remaining two fasteners of the four fasteners 1559 extend horizontally though the horizontal slot 1557 of the side wall 1552 of the post cap 1540 and extend through respective vertical slots 177 in the other side wall 175 of the upper mounting portion 172 of the support post 150. The four fasteners 1559 thereby secure the post cap 1540 to the upper mounting portion 172 of the support post 150.

The combination of the array of four arcuate slots 1558 of the horizontal upper wall 1542 of the post cap 1540, the two horizontally extending arcuate slots 1556, 1557 of the vertical side walls 1550, 1552 of the post cap 1540, the two pairs of vertical slots 176, 177 in the opposing side walls 174, 175 of the mounting portion 172 of the support post 170 advantageously allow for: a) limited rotational adjustability of the saddle assembly 1400 and the rotational bearing assembly 1300 with respect to the post cap 1540 to account for the post twist condition (as previously discussed); and b) limited linear adjustability of the saddle assembly 1400 and rotational bearing assembly 1300 in the Y horizontal direction (orthogonal to the axis of rotation R) to account for Y direction misalignment condition (as previously discussed); and c) limited linear adjustability in the vertical direction V and limited tilting of the saddle assembly 1400 and the rotational bearing assembly 1300 with respect to the central vertical axis PCVA of the support post 150 accounts for post tilt condition (as previously discussed). Advantageously, the connecting assembly 1500, along with the lower coupling portion 1402 of the saddle assembly 1400, provide the necessary degrees of freedom or degrees of adjustability to account for post twist, Y direction misalignment, and post tilt conditions, as discussed with respect to the connecting structure 500 of the bearing apparatus 200 of the first exemplary embodiment.

In one exemplary embodiment, the first and second bearing members 1350, 1370 of the rotatable bearing assembly 1300 and the first and second saddle members 1450, 1470 of the saddle assembly 1400 are fabricated of cast aluminum. The first and second bearing members 1350, 1370 and first and second saddle members 1450, 1470 could also be made of other materials having similar characteristics or properties including but not limited to cast steel, machined aluminum, machined steel and molded polymer. In one exemplary embodiment, the components of the connecting assembly 1500 are made of steel, but could also be made of aluminum or a polymer or filled or reinforced polymer.

### Third Exemplary Embodiment—Solar Tracker Bearing Assembly 2200

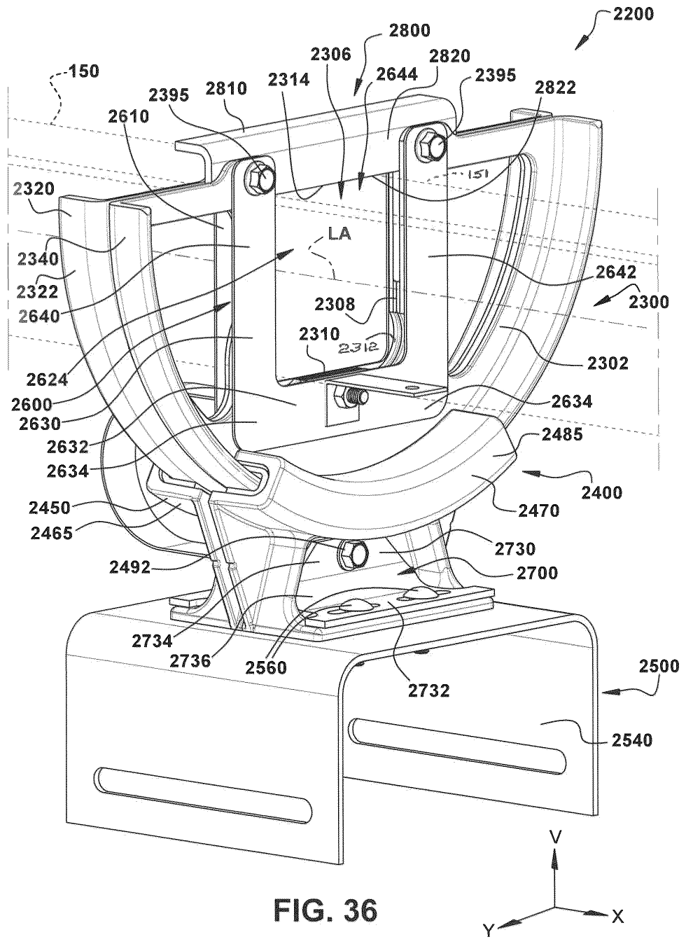

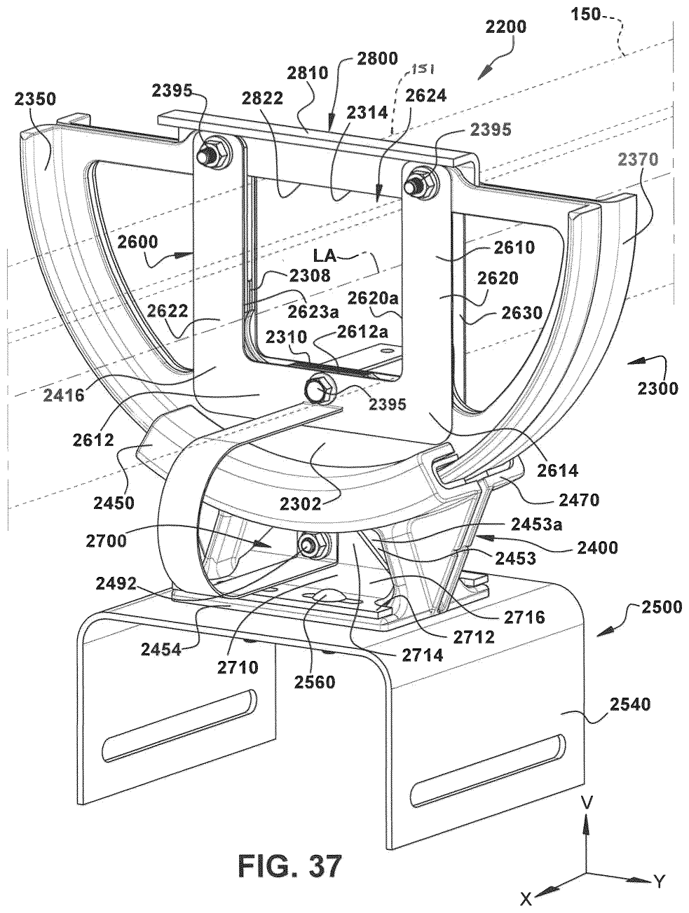

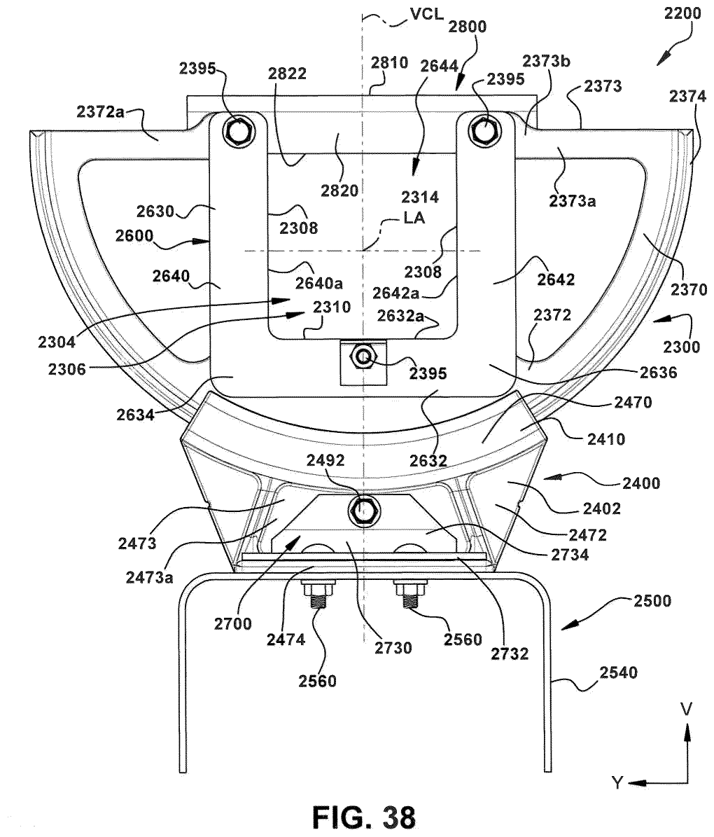

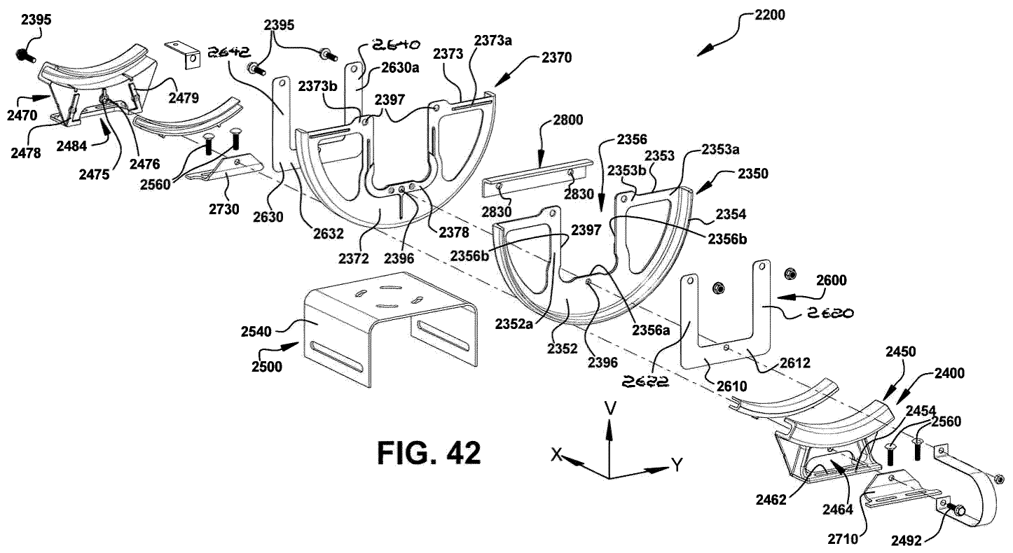

A third example or exemplary embodiment of a solar tracker bearing assembly or solar tracker bearing apparatus of the present disclosure is shown generally at 2200 in FIGS. 36-42. The solar tracker bearing apparatus 2200 is similar in structure and function to the solar tracker bearing apparatus 1200 of the second exemplary embodiment and may be utilized in connection with the solar tracker system or solar tracker assembly 100, as previously described. The description and disclosures, including drawings, relating to the solar tracker bearing apparatus 1200, the solar tracker bearing apparatus 2200, and the solar tracker system 100 are incorporated herein by reference as supplemental to the description of the solar tracker bearing apparatus 2200 and, for brevity, discussion of components, structure and functions common or applicable to either of the solar tracker bearing apparatus embodiments 200, 1200 will not be repeated in its entirety.

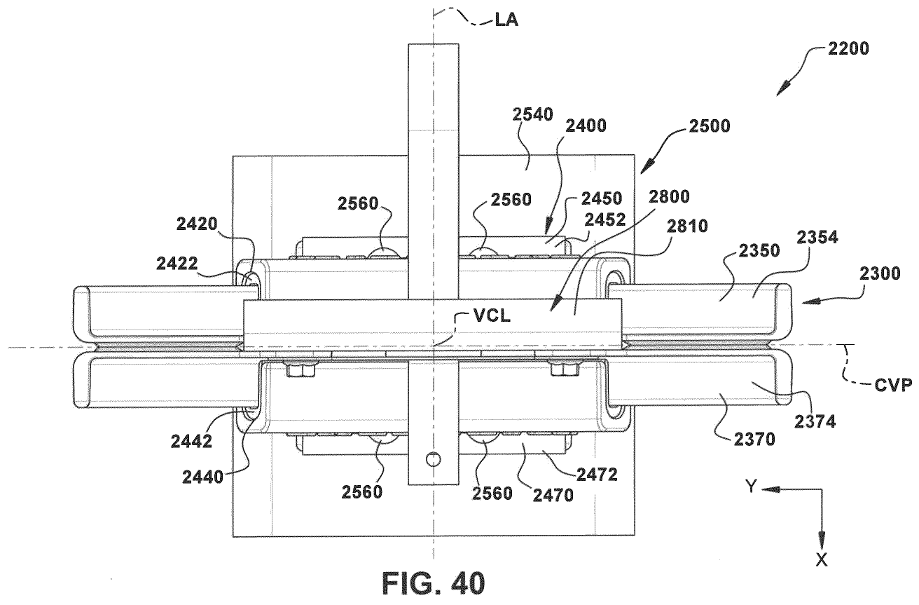

As with the solar tracker bearing apparatus 1200, the solar tracker bearing apparatus 2200 of the third example embodiment includes a rotatable bearing assembly 2300 supported for rotation about an axis of rotation R by a stationary saddle assembly 2400. The axis of rotation R of the rotatable bearing assembly 2300 is substantially the same as the axis of rotation R of the rotatable bearing assembly 1300 of the solar tracker bearing apparatus 1200 of the second embodiment, as schematically depicted in FIG. 19. The rotatable bearing assembly 2300 and the stationary saddle assembly 2400 of the solar tracker bearing apparatus 2200 are both two-part assemblies that are symmetric about a central vertical plane CVP (FIG. 40). The rotatable bearing assembly 2300 includes first and second axially spaced apart bearing members 2350, 2370. The first bearing member 2350 includes a first arcuate rim bearing 2322 and the second bearing member 2370 includes a second arcuate rim bearing 2342. Each of the bearing members 2350, 2370 include u-shaped cuts-outs 2356, 2376 defining a torque tube beam slot 2306 for supporting a torque tube beam portion 151 of the torque tube beam 150 (shown in dashed line in FIGS. 36 & 37). The stationary saddle assembly 2400 includes a lower coupling portion 2402, which is connected to a post cap 2540 of a connecting assembly 2500 of the solar tracker bearing apparatus 2200, and an upper bearing portion 2410. The upper bearing portion 2410 of the stationary saddle assembly 2400 extends from and is supported by the lower coupling portion 2402. In one example embodiment, the stationary saddle assembly 2400, similarly to stationary saddle assembly 1400, includes first and second axially spaced apart saddle members 2450, 2470. The first saddle member 2450 includes a first arcuate bearing race 2422 and an upper bearing region 2485 of the second saddle member 2470 includes a second arcuate bearing race 2442. The first and second arcuate bearing races 2422, 2442 support the rotatable bearing assembly 2300, and the torque tube beam portion 151, for rotation through an angle of inclination AI of the table 110, as previously described. The first arcuate rim bearing 2322 of the upper bearing region 2465 of the first bearing member 2350 of the rotatable bearing assembly 2300 is slidingly supported by the first arcuate bearing race 2422 of the first saddle member 2450 of the saddle assembly 2400, while the second arcuate rim bearing 2342 of the second bearing member 2350 is slidingly supported by the second arcuate bearing race 2442 of the second saddle member 2470.

The upper bearing regions 2465, 2485 of the first and second saddle members 2450, 2470 extend from and are supported by lower support regions 2452, 2472. The lower support regions 2452, 2472 of the first and second saddle members 2450, 2470 of the saddle assembly 2499, in turn, are coupled to the connecting assembly 2500 of the solar tracker bearing apparatus 2200 for adjustably securing the saddle assembly 2400 to an upper mounting portion 172 of a mounting post 170, as previously described and as shown in, for example, FIG. 17.

Advantageously, the rotatable bearing assembly 2300 of the third example embodiment includes a set of beam slot reinforcement members 2600 which function to enhance the rigidity and strength of the rotatable bearing assembly 2700 in the region of the torque tube beam slot 2306. Because of the rotation of the torque tube beam through the angle of inclination AI, the torque tube beam slot 2306 of the rotatable bearing assembly 2300 is subjected to large twisting or torsional force loads, in addition to a downward gravitational force load resulting from a proportional weight of the table 100 being supported by a given solar tracker bearing apparatus 2200. Moreover, since the torque tube beam segment 151 is securely held in the torque tube beam slot 2306 by a hold-down bracket 2800 of the rotatable bearing assembly 2300, the rotatable bearing assembly 2300 may be subject to axial loads along the longitudinal axis LA of the torque tube beam 150 resulting from, for example, wind gusts experienced by the solar tracker assembly 100 in a north-south direction. Accordingly, increasing the rigidity and strength of the rotatable bearing assembly 2700 in the region of the torque tube beam slot 2306 mitigates the effect of such forces being applied to the rotatable bearing assembly 2700 and may enable designers to reduce the number of solar tracker bearing apparatuses require for a solar tracker assembly having given length, size and weight parameters and/or increase the expected useful life of the solar tracker bearing apparatuses.

Additionally and advantageously, the first and second saddle members 2450, 2470 of the saddle assembly 2400 of the third example embodiment includes a set of saddle reinforcement members 2700 which function to enhance the rigidity and strength of the saddle assembly 2400 by bridging and thereby reinforcing horizontal and vertical portions of the lower support regions 2452, 2472 of the first and second saddle members 2450, 2470 of the saddle assembly 2400. The torsional, axial and gravitational load forces discussed above are transmitted through the rotatable bearing assembly 2700 to the saddle assembly 2400 by virtue of: a) the sliding bearing interface between the first bearing member 2350 of the rotatable bearing assembly 2700 and the first arcuate bearing race 2422 of the upper bearing region 2465 of the first saddle member 2450; and b) the sliding bearing interface between the second bearing member 2370 of the rotatable bearing assembly 2700 and the second arcuate bearing race 2442 of the upper bearing region 2485 of the second saddle member 2470. Accordingly, increasing the rigidity and strength of the lower support regions 2452, 2472 of the first and second saddle members 2450, 2470 of the saddle assembly 2400 mitigates the effect of such forces being applied to the saddle assembly 2400 and may enable designers to reduce the number of solar tracker bearing apparatuses require for a solar tracker assembly having given length, size and weight parameters and/or increase the expected useful life of the solar tracker bearing apparatuses.

### Rotatable Bearing Assembly 2300

As can best be seen in FIGS. 36-42, in one exemplary embodiment, the rotatable bearing assembly 2300 includes a central portion or region 2302 and first and second spaced apart arcuate peripheral portions or regions 2320, 2340. The central portion 2302 of the bearing assembly 2300 includes a channel 2304 defining a torque tube beam slot 2306 for receiving a torque tube beam portion or segment 151 of the torque tube beam 150. The beam slot 2306 includes spaced apart vertical side walls 2308 and the horizontally extending lower wall 2310. An upper wall 2314 of the beam slot 2306 is formed by an L-shaped hold-down bracket 2800. In one exemplary embodiment, the L-shaped bracket 2800 includes a generally planar horizontal portion or leg 2810 and a generally planar vertical portion or leg 2820 extending downwardly from the horizontal portion 2810. A lower edge or surface 2822 of the vertical portion 2820 of the L-shaped hold down bracket 2800 defines the upper wall 2314 of the beam slot 2306. The beam slot 2306 receives and supports the square cross-sectional shape of the torque tube beam segment 151 of the torque tube 150. The first peripheral portion 2320 of the rotatable bearing assembly 2300 includes a first arcuate rim bearing 2322 and the second peripheral portion 2340 includes a second arcuate rim bearing 2342. The first and second rim bearings 2322, 2342 are spaced apart as viewed in an axial direction, that is, as measured or viewed along the axis of rotation R of the rotatable bearing assembly 2300 (stated another way, spaced apart as measured in the horizontal direction X) and are centered about the axis of rotation R. Further, the first and second rim bearings 2322, 2342, as viewed with respect to the axis of rotation R, have substantially the same radius. The first rim bearing 2322 is part of a first bearing member 2350 and the second rim bearing 1342 is part of a second bearing member 2370, which, in one exemplary embodiment, are identical parts. To facilitate a flush fit between the portion 151 of the torque tube beam 150 received in the beam slot 2306 and, specifically, to facilitate a flush fit between side walls 158 of the torque tube beam portion 151 and the opposing side walls 22308 of the beam slot 2306 and between the lower wall 157 of the torque tube beam portion 151 and the bottom wall 2310 of the beam slot 1306 and to facilitate ease of removal of the torque tube beam portion 151 from the beam slot 2306, there are double radius recesses 2312 (one of which can be seen in FIG. 36) forming the corner transitions between the opposing side walls 2308 and the bottom wall 2310 of the beam slot 2306.

In one exemplary embodiment, like the rotatable bearing assemblies 300, 1300 of the solar tracker bearing apparatuses 200, 1200 of the first and second embodiments, the rotatable bearing assembly 2300 of the solar tracker bearing apparatus 2200 is a two-part assembly that is symmetric about the central vertical plane CVP extending through the solar tracker bearing apparatus 2200. The central vertical plane CVP of the solar tracker bearing apparatus 2200 includes the vertical center line VCL of the bearing apparatus 2200 that intersects and is orthogonal to the axis of rotation R of the rotatable bearing assembly 2300.

The first bearing member 2350 of the rotatable bearing assembly 2300 is generally semicircular including a generally planar central portion or region 2352 and a laterally extending peripheral rim 2354. The planar central portion 2352 is substantially parallel to but spaced laterally from the central vertical plane CVP of the solar tracker bearing apparatus 2200. The planar central region 2352 includes a generally u-shaped cut-out 2356 extending vertically downwardly from an upper edge 2353 of the central region 2352. The u-shaped cut-out 2356 includes a horizontally extending lower surface 2356a and a pair of opposing vertically extending side surfaces 2356b.

Like the first bearing member 2350, the second bearing member 2370 is generally semicircular including a generally planar central region or portion 2372 and a laterally extending peripheral rim 2374. The planar central region or portion 2372 is substantially parallel to but spaced laterally from the central vertical plane CVP of the solar tracker bearing apparatus 2200. The central region 2372 includes a generally u-shaped cut-out 2376 extending vertically downwardly from an upper edge 2373 of the central region or portion 2372. The u-shaped cut-out 2376 includes a horizontally extending lower surface 2376a and a pair of opposing vertically extending side surfaces 2376b. In one exemplary embodiment, the first and second bearing members 2350, 2370 and, specifically, the planar central regions 2352, 2372 are spaced apart axially (that is, as measured along the rotatable bearing member axis of rotation R) by the aligned contact of first and second projections and the aligned contact of first and second set of protuberances, as previously described with respect to the solar tracker bearing apparatus 1200. Facing surfaces of the first and second projections and facing surfaces of the first and second set of protuberances engage along the central vertical plane CVP of the bearing apparatus 2200.

In one exemplary embodiment, the first and second bearing members 2350, 2370 are secured together by three fasteners 2395 that pass through aligned openings 2396, 2397 of the central regions or portions 2352, 2372 of the first and second bearing members 2350, 2370. In one exemplary embodiment, the three fasteners 2395 are conventional bolt and nut fasteners. The first opening 2396 is centered just below the lower wall 2310 of the torque tube beam slot 2306 and passes though respective bases 2360, 2380 of the first and second projections 2358, 2378 of the first and second bearing members 2350, 2370. The second and third openings 2397 are on opposite sides of the torque tube beam slot 2306 and pass through respective enlarged, dog-eared upper sections 2353b, 2373b of upper portions 2353a, 2373b of the central regions 2352, 2372 of the first and second bearing members 2350, 2370. The L-shaped hold down bracket 2800 also includes a pair of openings 2830 aligned with second and third openings 2397 of the respective dog-eared upper sections 2353b, 2373b of the upper portions 2353a, 2373b of the central regions 2353, 2373 of the of the first and second bearing members 2350, 2370 to allow for passage of the upper two of the three fasteners 2395.

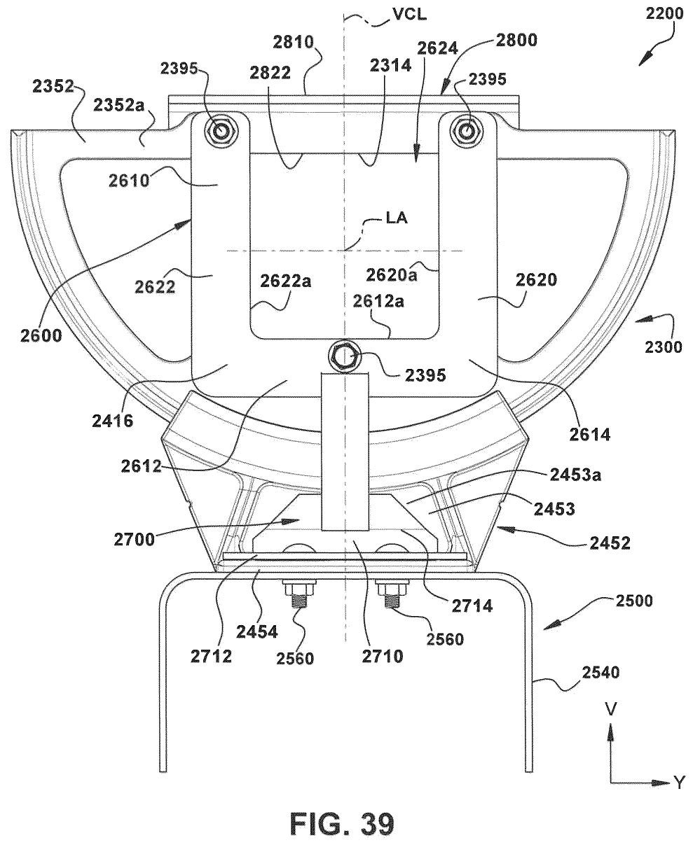

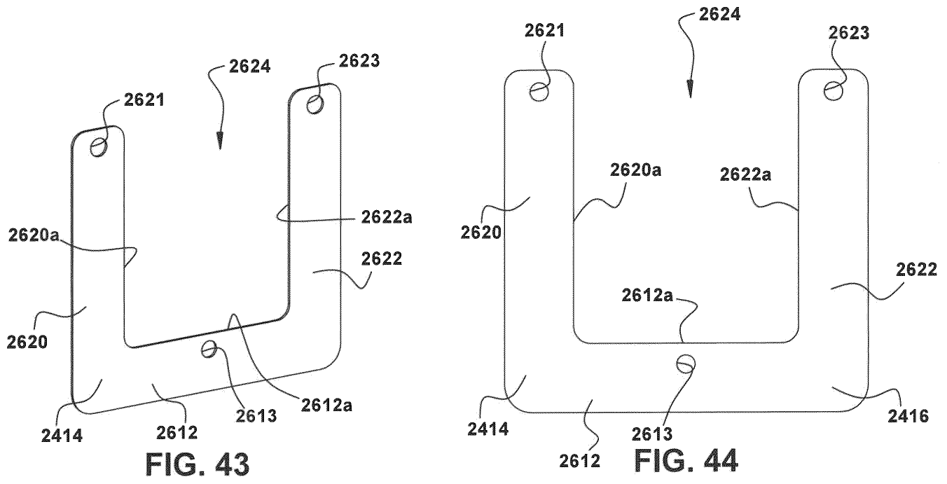

As compared to the rotatable bearing assembly 1300, the rotatable bearing assembly 2300 of the solar tracker bearing apparatus 2200 additionally includes the set of beam slot reinforcement members 2600. In one exemplary embodiment, the set of beam slot reinforcement members 2600 include identical first and second reinforcement members 2610, 2630. As best seen in FIGS. 39 and 41-44, the first reinforcement member 2610 is generally u-shaped including a horizontal base 2612 having first end second end portions 2614, 2616. Extending vertically upwardly from the first and second end portions 2614, 2616 of the horizontal base 2612 are respective upright members 2620, 2622.

Respective inner edges 2612a, 2620a, 2622a of the base 2612 and the upright members 2620, 2622 define a u-shaped opening 2624 that is aligned with and generally comports with dimensions of the u-shaped cut-out 2356 in central region 2352 of the first bearing member 2350. That is, the u-shaped opening 2624 of the first reinforcement member 2610 is adapted and configured to receive the torque tube beam portion 151 of the torque tube beam 150. Specifically, in one example embodiment, the inner edge 2612a of the horizontal base 2612 is adjacent to and effectively extends, in the axial direction, the horizontal lower wall 2310 of the torque tube beam slot 2306 of the rotatable bearing assembly 2300. The inner edge 2612a of the horizontal base 2612 bears against the lower wall 157 of the torque tube beam portion 151. The inner edges 2620a, 2622a of the upright members 2620, 2622 are adjacent to and effectively slightly extend, in the axial direction, respective side walls 2308 of the torque tube beam slot 2306 of the rotatable bearing assembly 2300. The inner edges 2620a, 2622a of the upright members 2620, 2622 bear against respective side walls 158 of the torque tube beam portion 151. A planar back side 2610a of the first reinforcement member 2610 contacts and bears flush against an outward facing surface 2352a of the planar central region 2352 of the first bearing member 2350.

Similarly, the second reinforcement member 2630 is generally u-shaped including a horizontal base 2632 having first end second end portions 2634, 2636. Extending vertically upwardly from the first and second end portions 2634, 2636 of the horizontal base 2632 are respective upright members 2640, 2642. Respective inner edges 2632a, 2640a, 2642a of the base 2632 and the upright members 2640, 2642 defining a u-shaped opening 2644 that is aligned with and generally comports with dimensions of the u-shaped cut-out 2376 in central region 2372 of the second bearing member 2370. That is, the u-shaped opening 2644 of the second reinforcement member 2630 is adapted and configured to receive the torque tube beam portion 151 of the torque tube beam 150. Specifically, in one example embodiment, the inner edge 2632a of the horizontal base 2632 is adjacent to and effectively extends, in the axial direction, the horizontal lower wall 2310 of the torque tube beam slot 2306 of the rotatable bearing assembly 2300. The inner edge 2632a of the horizontal base 2632 bears against the lower wall 157 of the torque tube beam portion 151. The inner edges 2640a, 2642a of the upright members 2640, 2642 are adjacent to and effectively slightly extend, in the axial direction, respective side walls 2308 of the torque tube beam slot 2306 of the rotatable bearing assembly 2300. The inner edges 2640a, 2642a of the upright members 2640, 2642 bear against respective side walls 158 of the torque tube beam portion 151. A planar back side 2630a of the second reinforcement member 2630 contacts and bears flush against an outward facing surface 2372a of the planar central region 2372 of the first bearing member 2370.

The first beam slot reinforcement member 2610 includes three openings: a) a first opening 2612a in the horizontal base 2612; b) a second opening 2620a in the upright member 2620; and c) a third opening 2622a in the upright member 2622. Similarly, the second beam slot reinforcement member 2630 includes three openings: a) a first opening 2632a in the horizontal base 2632; b) a second opening 2640a in the upright member 2640; and c) a third opening 2642a in the upright member 2642. The respective first openings 2612a, 2632a of the first and second beam slot reinforcement members 2610, 2630 are aligned with corresponding openings 2396 of the central regions 2352, 2372 of the first and second bearing members 2350, 2370 thereby allowing passage of the first fastener of the three fasteners 2395 through the first and second bearing members 2350 to secure the first and second bearing members together. The respective second openings 2620a, 2640a of the first and second beam slot reinforcement members 2610, 2630 are aligned with corresponding openings 2396 of the central regions 2352, 2372 of the first and second bearing members 2350, 2370 thereby allowing passage of the second fastener of the three fasteners 2395 through the first and second bearing members 2350 to secure the first and second bearing members together. The respective third openings 2622a, 2642a of the first and second beam slot reinforcement members 2610, 2630 are aligned with corresponding openings 2396 of the central regions 2352, 2372 of the first and second bearing members 2350, 2370 thereby allowing passage of the third fastener of the three fasteners 2395 through the first and second bearing members 2350 to secure the first and second bearing members together.

### Saddle Assembly 2400

As can best be seen in FIGS. 36-39 and 41-42, the saddle assembly 2400 includes the lower coupling portion 2402 and the upper bearing portion 2410. The upper bearing portion 2410 includes a first arcuate slot 2420 and a second arcuate slot 2440. The first arcuate slot 2420 includes a first arcuate bearing race 2422 and the second arcuate slot 2440 includes a second arcuate bearing race 2442. The first and second arcuate bearing races 2422, 2442 are spaced apart as viewed in an axial direction, that is, as measured or viewed along the axis of rotation R of the rotatable bearing assembly 2300 (stated another way, spaced apart as measured in the horizontal direction X) and are centered about the axis of rotation R. The first arcuate bearing race 2422 slidably supports the first arcuate rim bearing 2322 of the rotatable bearing assembly 2300 and the second arcuate bearing race 2442 slidably supports the second arcuate rim bearing 2342 of the rotatable bearing assembly 2300 such that the arcuate or pivoting movement of the rotatable bearing assembly 2300 is centered about the axis of rotation R. The upper bearing portion 2410 is similar in function and structure to the upper bearing portion 410 of the saddle assembly 400 of the first embodiment and the upper bearing portion 1410 of the saddle assembly 1400 of the second embodiment.

The saddle assembly 2400, in one exemplary embodiment, like the bearing assembly 2300, is a two piece assembly comprising a first saddle member 2450 and a second saddle member 2470 which are identical and symmetric about the central vertical plane CVP of the solar tracker bearing apparatus 1200. The first saddle member 2450 includes an upper bearing region 2465 and a lower support region 2452 that is coupled to and supports the upper bearing region 2465. The lower support region 2452 of the first saddle member 1450 includes a downwardly or vertically extending plate 2453 and an orthogonally extending flange 2454 extending from a lower end region of the plate 2453. The plate 1453 includes a generally planar first surface 2453a facing in the direction toward an aligned lower support region 2472 of the second saddle member 2470. The plate 2453 includes a boss 2455 defining an opening 2456 extending through the plate 2453.

The second saddle member 2470 similarly includes an upper bearing region 2485 and the lower support region 2472 that is coupled to and supports the upper bearing region 2475. The respective upper bearing regions 2465, 2485 of the first and second saddle members comprise the upper bearing portion 2410 of the saddle assembly 2400. The respective lower support regions 2452, 2472 comprise the lower coupling portion 2402 of the saddle assembly 2400. The lower support region 2472 of the second saddle member 1470 includes a downwardly or vertically extending plate 2473 and an orthogonally extending flange 2474 extending from a lower end region of the plate 2473. The plate 2473 includes a generally planar second surface 2473a facing in the direction toward the aligned plate 2453 of the lower support region 2452 of the first saddle member 2450. The plate 2473 includes a boss 2475 defining an opening 2476 extending through the plate 2473. A fastener 2492, such as a conventional bolt and nut fastener assembly, pass through the aligned openings 2456, 2476 of the plates 2453, 2473 of the lower support regions 2452, 2472 of the first and second saddle members 2450, 2470 secure the first and second saddle members 2450, 2470 together.

The planar first surface 2453a of the plate 2453 of the lower support region 2452 of the first saddle member 2450 further includes a first projection 2458 that extends axially from the planar first surface 2453a in the horizontal direction X toward the planar second surface 2473a of the second saddle member 2470. The planar second surface 2473a of the plate 2473 of the lower support region 2472 the second saddle member 1470 similarly includes a second projection 2478 that extends axially from the planar second surface 2473a in the horizontal direction X toward the planar first surface 2453a. That is, the second projection 2478 extends axially from the second surface 2473a in a direction toward the central vertical plane CVP of the bearing apparatus 2200. Facing surfaces 2459, 2479 of the first and second projections 2458, 2478 of the lower support regions 2452, 2472 of the first and second saddle members 2450, 2470 engage and contact to axially space apart the first and second surfaces 2453a, 2473a and thereby axially space apart the lower support regions 2452, 2472 of the first and second saddle members 2450, 2470. Each of the first and second surfaces 2453a, 2473a are spaced equidistant from the central vertical plane CVP of the solar tracking bearing apparatus 2200.

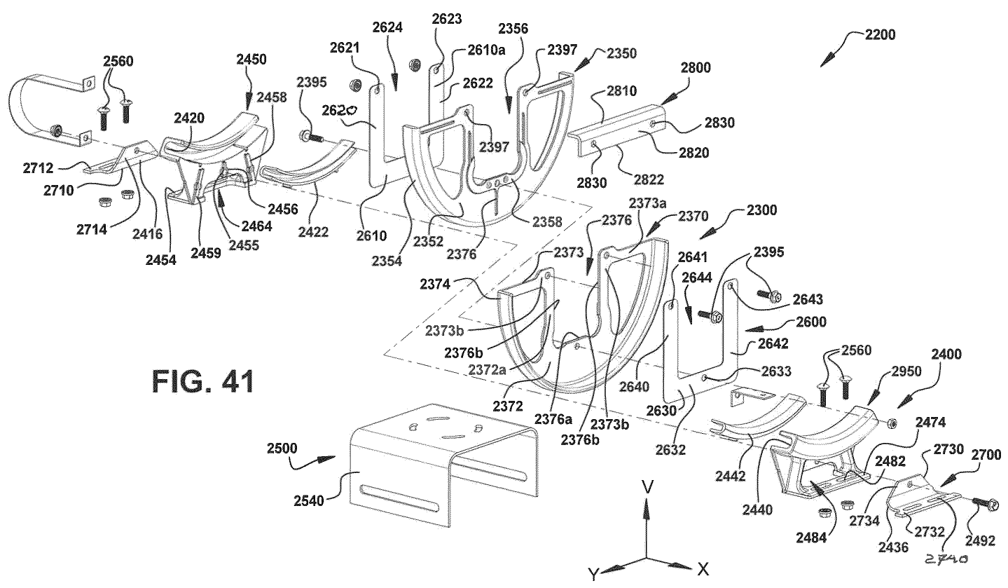

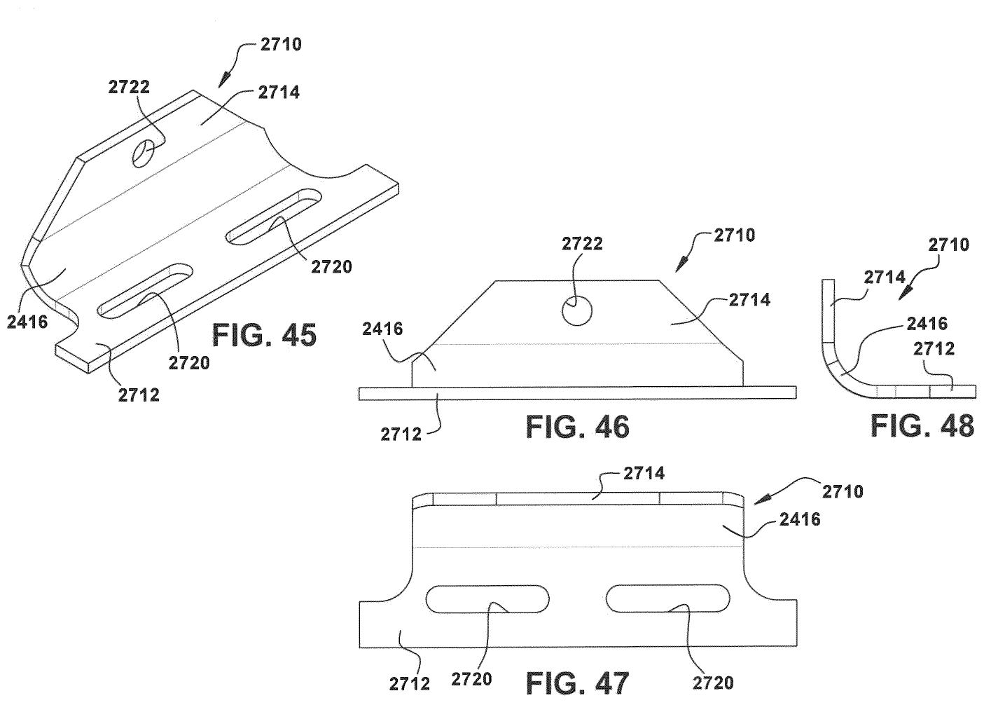

As compared to the solar tracker bearing apparatus 1200, the solar tracker bearing apparatus 2200 additionally includes the set of saddle reinforcement members 2700. In one example embodiment, the set of saddle reinforcement members 2700 include substantially identical first and second saddle reinforcement members 2710, 2730. As best seen in FIGS. 41-42 and 45-48, the first saddle reinforcement member 2710 is right-angled and bridges a vertical plate 2453 and a horizontal flange 2454 of the lower support region 2452 of first saddle member 2450 to thereby reinforce and strengthen the first saddle member 2350. Similarly, the second saddle reinforcement member 2730 is right-angled and bridges a vertical plate 2473 and a horizontal flange 2474 of the lower support region 2472 of second saddle member 2470 to thereby reinforce and strengthen the second saddle member 2370.

In one example embodiment, the first saddle reinforcement member 2710 includes a horizontal pedestal or base 2712 and a vertical projection or upright 2714 connected by an arcuate web portion 2716 between the horizontal base 2712 and the vertical projection 2714. The vertical projection 2714 of the first saddle reinforcement member 2710 is generally trapezoidal in shape, as viewed in front elevation view, while the horizontal base 2712 is generally rectangular, as viewed in top plan view, with a necked-down or narrowed transition region into the arcuate web portion 2716. The arcuate web 2716 is curved at a 90° angle, as viewed in side elevation view. to transition between the horizontal base 2712 and the vertical upright or projection 2714. The first saddle reinforcement member 2710 overlies and covers or partially covers a gap or cavity 2460 between the horizontal flange 2454 and the vertical plate 2453 of the lower support region 2452 of the first saddle member 2450.

The horizontal pedestal or base 2712 of the first saddle reinforcement member 2710 includes a pair of slotted openings 2720 which are aligned with a pair of slotted openings 2462 in the flange 2454 of the lower support region 2452 of the first saddle member 2450. The pair of slotted openings 2720 of the base 2712 and the pair of slotted openings 2462 of the flange 2454 are aligned to receive respective two fasteners of a total of four fasteners 2560 which secure the saddle assembly 2400 to the post cap 2540 of the connecting assembly 2500, as previously described with respect to solar tracker bearing apparatus 1200. The vertical projection 2714 includes an opening 2742 aligned with an opening 2476 extending through the vertical plate 2473 of the lower support region 2472 of the second saddle member 2450. The aligned openings 2742, 2476 receive a fastener 2392 securing the first and second saddle members 2450, 2470 together.

Similarly, in one example embodiment, the second saddle reinforcement member 2730 includes a horizontal pedestal or base 2732 and a vertical projection or upright 2734 connected by an arcuate web portion 2736 between the horizontal base 2732 and the vertical projection 2734. The vertical projection 2734 of the second saddle reinforcement member 2730 is generally trapezoidal in shape, as viewed in front elevation view, while the horizontal base 2732 is generally rectangular, as viewed in top plan view, having a necked-down r narrowed transition region into the arcuate web portion 2736. The arcuate web 2736 is curved at approximately a 90° angle, as viewed in side elevation view, to transition between the horizontal base 2732 and the vertical upright or projection 2734. The second saddle reinforcement member 2730 overlies and covers or partially covers a gap or cavity 2484 between the horizontal flange 2474 and the vertical plate 2473 of the lower support region 2472 of the first saddle member 2470.

The horizontal pedestal or base 2732 of the second saddle reinforcement member 2730 includes a pair of slotted openings 2740 which are aligned with a pair of slotted openings 2482 in the flange 2474 of the lower support region 2472 of the second saddle member 2470. The pair of slotted openings 2740 of the base 2732 and the pair of slotted openings 2462 of the flange 2454 are aligned to receive respective two fasteners of a total of four fasteners 2560 which secure the saddle assembly 2400 to a post cap 2540 of the connecting assembly 2500, as previously described with respect to solar tracker bearing apparatus 1200. The vertical projection 2734 includes an opening 2742 aligned with an opening 2476 extending through the vertical plate 2473 of the lower support region 2472 of the second saddle member 2450. The aligned openings 2742, 2476 receive a fastener 2392 securing the first and second saddle members 2450, 2470 together.

As used herein, terms of orientation and/or direction such as upward, downward, forward, rearward, upper, lower, inward, outward, inwardly, outwardly, horizontal, horizontally, vertical, vertically, distal, proximal, axially, radially, etc., are provided for convenience purposes and relate generally to the orientation shown in the Figures and/or discussed in the Detailed Description. Such orientation/direction terms are not intended to limit the scope of the present disclosure, this application and the invention or inventions described therein, or the claims appended hereto.

What have been described above are examples of the present disclosure/invention. It is, of course, not possible to describe every conceivable combination of components, assemblies, or methodologies for purposes of describing the present disclosure/invention, but one of ordinary skill in the art will recognize that many further combinations and permutations of the present disclosure/invention are possible. Accordingly, the present disclosure/invention is intended to embrace all such alterations, modifications, and variations that fall within the spirit and scope of the appended claims.

What is claimed is:

1. A solar tracker bearing apparatus mountable to a support post for pivotally supporting a support beam of a solar tracker assembly, the solar tracker bearing apparatus comprising:
a rotatable bearing assembly supported for rotation about an axis of rotation by a saddle assembly, the rotatable bearing assembly including a first bearing member and a second bearing member, the first bearing member including a central portion and a first arcuate peripheral portion and the second bearing member including a central portion and a second arcuate peripheral portion, the central portion of the first bearing member and the central portion of the second bearing member defining a beam slot, the first arcuate peripheral portion of the first bearing member including a first arcuate rim bearing and the second arcuate peripheral portion of the second bearing member including a second arcuate rim bearing, the first and second rim bearings being spaced apart in a direction parallel to the axis of rotation of the rotatable bearing assembly;
a set of beam slot reinforcement members including a first beam slot reinforcement member affixed to the central portion of the first bearing member adjacent the beam slot; and
the saddle assembly including a first arcuate bearing race and a spaced apart second arcuate bearing race, the first arcuate bearing race slidably supporting the first arcuate rim bearing of the rotatable bearing assembly and the second arcuate bearing race slidably supporting the second arcuate rim bearing of the rotatable bearing assembly.

2. The solar tracker bearing apparatus of claim 1 wherein the set of beam slot reinforcement members further includes a second beam slot reinforcement member affixed to the central portion of the second bearing member adjacent the beam slot.

3. The solar tracker bearing apparatus of claim 1 wherein the first beam slot reinforcement member is affixed to an outwardly facing surface of the central portion of the first bearing member.

4. The solar tracker bearing apparatus of claim 2 wherein the second beam slot reinforcement member is affixed to an outwardly facing surface of the central portion of the second bearing member.

5. The solar tracker bearing apparatus of claim 1 wherein the first beam slot reinforcement member includes a base and a pair of uprights defining a u-shaped opening, the u-shaped opening aligned with the beam slot.

6. The solar tracker bearing apparatus of claim 2 wherein the second beam slot reinforcement member includes a base and a pair of uprights defining a u-shaped opening, the u-shaped opening aligned with the beam slot.

7. The solar tracker bearing apparatus of claim 1 wherein the first bearing member includes a first projection extending from the first bearing member central portion in a direction toward the second bearing member and the second bearing member includes a second projection extending from the second bearing member central portion in a direction toward the first bearing member, the first and second projections of the first and second bearing members being in contact and spacing apart the central portion of the first bearing member and the central portion of the second bearing member and forming a part of at least one of a bottom wall, a first side wall, and a second side wall of the beam slot, the first projection of the first bearing member central portion includes a first recess extending into the first projection and a first tab extending from the first projection in a direction toward the second bearing member and the second projection of the second bearing member central portion includes a second recess extending into the second projection and a second tab extending from the second projection in a direction toward the first bearing member, the first tab of the first projection being received in the second recess of the second projection and the second tab of the second projection being received in the first recess of the first projection.

8. The solar tracker bearing apparatus of claim 7 wherein the central portion of the first bearing member includes a cut-out defining a portion of the beam slot and the first projection is generally u-shaped as viewed with respect to a plane orthogonal to the axis of rotation of the rotatable bearing assembly and is adjacent the cut-out of the first bearing member central portion and wherein the central portion of the second bearing member includes a cut-out defining a portion of the tube beam slot and the second projection is generally u-shaped as viewed with respect to a plane orthogonal to the axis of rotation of the rotatable bearing assembly and is adjacent the cut-out of the second bearing member central portion.

9. The solar tracker bearing apparatus of claim 7 wherein the central portion of the first bearing member additionally includes a first set of protuberances extending from the first bearing member central portion in a direction toward the first bearing member and the central portion of the second bearing member additionally includes a second set of protuberances extending from the second bearing member central portion in a direction toward the first bearing member, the first and second set of protuberances being in contact and spacing apart the central portion of the first bearing member and the central portion of the second bearing member.

10. The solar tracker bearing apparatus of claim 9 wherein the first set of protuberances includes a first rib, a second rib and a third rib extending from the first projection and further wherein the second set of protuberances includes a first rib, a second rib and a third rib extending from the second projection, the first rib of the first set of protuberances contacting the first rib of the second set of protuberances, the second rib of the first set of protuberances contacting the second rib of the second set of protuberances and the third rib of the first set of protuberances contacting the third rib of the second set of protuberances and spacing apart the central portion of the first bearing member and the central portion of the second bearing member.

11. The solar tracker bearing apparatus of claim 8 wherein the cut-out of the first bearing member central portion is generally u-shaped as viewed with respect to a plane orthogonal to the axis of rotation of the rotatable bearing assembly and includes a lower surface and first and second side surfaces and the first projection includes a base extending along at least a portion of the lower surface of the cut-out and first and second arms extending from the base and extending along at least a portion of first and second side surfaces of the cut-out.

12. The solar tracker bearing apparatus of claim 8 wherein the cut-out of the second bearing member central portion is generally u-shaped as viewed with respect to a plane orthogonal to the axis of rotation of the rotatable bearing assembly and includes a lower surface and first and second side surfaces and the second projection includes a base extending along at least a portion of the lower surface of the cut-out and first and second arms extending from the base and extending along at least a portion of first and second side surfaces of the cut-out.

13. The solar tracker bearing apparatus of claim 1 wherein the saddle assembly includes a lower coupling portion and an upper bearing portion, the upper bearing portion including the first and second arcuate bearing races.

14. The solar tracker bearing apparatus of claim 1 further including a connecting assembly affixed to a lower coupling portion of the saddle assembly, the connecting assembly including a post cap includes a central planar section and a pair of vertically extending sides, the central planar section including an array of four arcuate slots, the coupling portion of the saddle assembly including four openings, each arcuate slot of the array of four arcuate slots receiving a fastener extending through an aligned one of the four openings of the coupling portion of the saddle assembly to secure the saddle assembly to the post cap.

15. A solar tracker bearing apparatus mountable to a support post for pivotally supporting a support beam of a solar tracker assembly, the solar tracker bearing apparatus comprising:
a rotatable bearing assembly supported for rotation about an axis of rotation by a saddle assembly, the rotatable bearing assembly including a first bearing member and a second bearing member, the first bearing member including a central portion and a first arcuate peripheral portion and the second bearing member including a central portion and a second arcuate peripheral portion, the central portion of the first bearing member and the central portion of the second bearing member defining a beam slot;
the saddle assembly including a first saddle member and a second saddle member, the first saddle member including an upper bearing region extending from a lower support region, the upper bearing region including a first arcuate bearing race slidably supporting the first arcuate rim bearing of the rotatable bearing assembly, the second saddle member including an upper bearing region extending from a lower support region, the upper bearing region including a second arcuate bearing race slidably supporting the second arcuate rim bearing of the rotatable bearing assembly, the lower support region of the first saddle member including a horizontal flange and a vertical plate and the lower support region of the second saddle member including a horizontal flange and a vertical plate; and
a set of saddle reinforcement members including a first saddle reinforcement member affixed between the horizontal flange and the vertical plate of the lower support region of the first saddle member and the second saddle reinforcement member affixed between the horizontal flange and the vertical plate of the lower support region of the first saddle member.

16. The solar tracker bearing apparatus of claim 15 where the set of saddle reinforcement members further includes a second saddle reinforcement member affixed between the horizontal flange and the vertical plate of the lower support region of the second first saddle member.

17. The solar tracker bearing apparatus of claim 15 wherein the first saddle reinforcement member includes a horizontal base and a vertical projection connected by a web portion, the horizontal base coupled to the horizontal flange of the lower support region of the first saddle member and the vertical projection coupled to the vertical plate of the lower support region of the first saddle member.

18. The solar tracker bearing apparatus of claim 16 wherein the second saddle reinforcement member includes a horizontal base and a vertical projection connected by a web portion, the horizontal base coupled to the horizontal flange of the lower support region of the second saddle member and the vertical projection coupled to the vertical plate of the lower support region of the second saddle member.

19. The solar tracker bearing apparatus of claim 15 wherein the first bearing member includes a first projection extending from the first bearing member central portion in a direction toward the second bearing member and the second bearing member includes a second projection extending from the second bearing member central portion in a direction toward the first bearing member, the first and second projections of the first and second bearing members being in contact and spacing apart the central portion of the first bearing member and the central portion of the second bearing member and forming a part of at least one of a bottom wall, a first side wall, and a second side wall of the beam slot, the first projection of the first bearing member central portion includes a first recess extending into the first projection and a first tab extending from the first projection in a direction toward the second bearing member and the second projection of the second bearing member central portion includes a second recess extending into the second projection and a second tab extending from the second projection in a direction toward the first bearing member, the first tab of the first projection being received in the second recess of the second projection and the second tab of the second projection being received in the first recess of the first projection.

20. The solar tracker bearing apparatus of claim 19 wherein the central portion of the first bearing member includes a cut-out defining a portion of the beam slot and the first projection is generally u-shaped as viewed with respect to a plane orthogonal to the axis of rotation of the rotatable bearing assembly and is adjacent the cut-out of the first bearing member central portion and wherein the central portion of the second bearing member includes a cut-out defining a portion of the tube beam slot and the second projection is generally u-shaped as viewed with respect to a plane orthogonal to the axis of rotation of the rotatable bearing assembly and is adjacent the cut-out of the second bearing member central portion.
